(19) United States
(12) Patent Application Publication
(10) Pub. No.: US 2003/0097296 A1
(43) Pub. Date: May 22, 2003

(54) Service transaction management system and process

(76) Inventor: David A. Putt, Avon, CT (US)

Correspondence Address: WIGGIN & DANA LLP, ATTENTION: PATENT DOCKETING, ONE CENTURY TOWER, P.O. BOX 1832, NEW HAVEN, CT, 06508-1832, US

(21) Appl. No.: 10/300,946

(22) Filed: Nov. 20, 2002

Related U.S. Application Data
(60) Provisional application No. 60/331,853, filed on Nov. 20, 2001.

(51) Int. Cl. G06F 17/60

(52) U.S. Cl. 705/11; 705/80

(57) ABSTRACT

A system and method are presented for managing service transactions. The method includes defining a project including a plurality of activities and qualifications and preparing a Request for Proposal (RFP) from the project definition. A plurality of service providers are notified of the RFP. Proposals are received from prospective service providers. The received proposals are ranked based on evaluations of past performance of the prospective service providers. The evaluations include weighted categories of activities and qualifications of the service providers, where the weight is a percentage value corresponding to a relative importance of the activities and qualification to the project. The method further includes selecting at least one of the prospective service providers to perform the project, negotiating terms of performance with the prospective service providers, monitoring performance of the project and, upon completion of the project, requesting evaluations of the performance.

### CROSS REFERENCE TO RELATED DOCUMENTS

Priority is herewith claimed under 35 U.S.C. §119(e) from copending U.S. Provisional Patent Application No. 60/331,853, filed Nov. 20, 2001, entitled “SERVICE TRANSACTION MANAGEMENT SYSTEM AND PROCESS,” by David A. Putt. The disclosure of this U.S. Provisional Patent Application is incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND OF THE INVENTION

1. Field of the Invention

The present invention relates generally to systems for managing service transactions and, more particularly, to systems for managing information between customers and providers of knowledge based services over a global communication network such as the Internet.

2. Description of Prior Art

The average Fortune 1000 company spends nearly $1.8 billion (USD) per year on services. For government and private sector organizations spending on services can be sixty to eighty percent (60% to 80%) of all expenditures. Knowledge services such as, for example, consulting, information technology, accounting, legal, advertising and outsourcing services are the most significant of these purchases because they have the greatest impact on the success of an organization. Unfortunately, most organizations (both private and governmental) have no established processes for sourcing (e.g., selecting) providers of knowledge services and for measuring performance (e.g., relative success or failure) of these providers in providing the requested services that met the service objectives and were completed on time and within budget. Clearly, organizations making expenditures of this magnitude without an adequate mechanism for sourcing and measuring the performance of providers are not in control of this aspect of their operations.

The inventor has found that organizations operating without disciplined processes for managing knowledge based services rarely have all the information required to make the best decisions when evaluating and negotiating with service providers. As a result, opportunities to improve service quality and reduce costs associated with procuring such services are often missed. At most organizations there are many missed opportunities and risks in knowledge services. Some perceived root causes of missed opportunities and risks are:

1. ad-hoc processes for knowledge services;

2. insufficient measurement and controls; and

3. islands of information.

1. Ad-hoc Processes for Knowledge Services.

The classification of ad-hoc processes for knowledge services encompasses several different aspects including, for example:

A. inconsistent enterprise wide sourcing standards;

B. sub-optimal sourcing decisions; and

C. lack of strategic focus.

A. Inconsistent Enterprise Wide Sourcing Standards.

Although spending on Knowledge Services is one of an organization's largest expenses, most organizations have no established sourcing practices. In a study performed by the Gartner Group, only seven (7) out of thirty (30) organizations interviewed had a strategy for hiring service firms. The study also showed the average time spent to hire a single service provider included two hundred ninety-nine (299) man-hours and cost seventy thousand dollars ($70,000 USD). The Gartner Group drew three major conclusions from the study. Firstly, enterprises spend more resources and dollars on sourcing services than they realize. Secondly, increased efficiencies in services sourcing will save significant time and dollars. Lastly, enterprises assume a significant amount of risk by not having an institutionalized process for managing relationships with service providers.

B. Sub-Optimal Sourcing Decisions

The Center for Advanced Purchasing Studies says that a purchasing department of an organization has much less involvement in the procurement of services than goods. Managers spread across different divisions, departments, and geographic locations are responsible for the complex task of evaluating and selecting service providers. Organizations (both governmental and private) can assist their managers in making better sourcing decisions by implementing a structured methodology for sourcing services and, in particular, knowledge services. Ultimately, better sourcing decisions lead to better quality of service, fewer cost overruns, project delays and ultimately fewer failed projects.

C. Lack of Strategic Focus

Consulting, information technology, and marketing services can have a tremendous impact on the overall performance of an organization, and also influence relationships with customers and suppliers. Linking knowledge services to an organization's business objectives insures that investments in projects lead to more profit, customer satisfaction, and increased shareholder value.

2. Insufficient Measurement and Controls

Insufficient measurement and controls over knowledge services are another significant problem facing organizations that purchase knowledge services for the simple fact that the organization can not improve what it can not measure. Because most organizations do not have a process for sourcing and measuring relationships with service providers, most of the information needed to manage knowledge services is never recorded. Information needed to answer important questions about relationships with providers of knowledge services in a way that is meaningful to the organization is difficult to collect. For example, key questions that go unanswered include:

Who are the top service providers?

What is the dollar value of the relationships we have with our top service providers?

How successful is each service provider at meeting project objectives?

Which service providers consistently deliver on-time and on-budget?

The lack of visibility to information needed to answer these questions makes it difficult to identify service providers that should become long term partners and those that consistently under perform. Knowledge of a few key metrics can have a large impact on a business manager's ability to make better sourcing decisions. For example, a manager who is aware that his organization spends fifty million dollars ($50,000,000 USD) per year with a service provider has much greater leverage to negotiate lower rates than a manager who only knows about their five hundred thousand dollar ($500,000 USD) project.

In many organizations, the effectiveness of purchasing is not being measured and can be improved substantially. A lack of tools and processes has not allowed organizations to improve the sourcing and management of knowledge services. Substantial cost savings can be achieved immediately by, for example:

Reducing the time spent sourcing;

Selecting the best service providers;

Eliminating cost overruns;

Eliminating failed projects;

Improving solution quality and return on investment (ROI); and

Negotiating the lowest rates.

Improved measurement and control delivers more than a one-time benefit. With ongoing analysis there is a cycle of continuous improvement that allows these benefits to accrue year after year.

3. Islands of Information

The information that is needed to improve knowledge services is distributed across multiple organizational divisions and sources. Because of this distribution the information needed to improve knowledge services is typically inaccessible. For example, some of the sources where this information reside are:

Contracts;

Spreadsheets;

Personal Computers;

Project Management Software;

Accounts Payable;

Accounting/ERP;

Procurement Systems; and

People.

The inventor has realized that a technology solution that captures and summarizes all the relevant information across the enterprise is needed. Because key information is not captured, no amount of data-mining or integration between existing information systems can fill this information gap.

One might consider if procurement software can be adapted to help manage knowledge services. The simple answer is “no”. Procurement systems facilitate purchases of materials and are primarily focused on optimizing price and delivery rather than expertise and skills. If the service provider does not have the right experience, it doesn't matter what price they charge. The project will fail.

Most large organizations manage their buyer/supplier relationships with material-oriented procurement and auction software systems. These software systems are designed to facilitate transactions of material goods. The purchase decisions for material goods are based primarily upon price and delivery and therefore can share a common framework to describe and manage each transaction. Knowledge services such as consulting, accounting, and other types of expertise, do not share a common framework for describing and evaluating transactions (e.g., projects). When buying knowledge services the knowledge of the service provider is a major consideration within the purchase decision and must be included within any competitive analysis between service providers. Material-oriented processes and systems are not designed to perform this type of evaluation and analysis and cannot be easily modified to meet these needs.

Knowledge services also occur over a period of days, months or years rather than at a specific point in time. Important information about a project is created throughout the life of the project and must be captured throughout the complete life of the project. Transactions involving materials occur at specific points in time (e.g., at ordering and delivery). Material-oriented procurement systems lack the ability to capture the information that is created during a project.

Without complete information the measurement and analysis of transactions aggregate across an organization is not possible. These characteristics make material procurement solutions ill suited to the sourcing and managing of relationships between a client and its service providers.

As illustrated above, knowledge services have unique complexities not addressed by existing procurement software. Knowledge services vary greatly from one another. For instance, the methods and criteria that are important when evaluating an advertising agency are very different from those used to evaluate an accounting firm. Accordingly, a different framework for defining and evaluating different types of service transactions and relationships is needed. The variations, methods and criteria for measuring the variations are significant differentiator within knowledge services.

Additionally, information regarding client/service provider relationships are distributed throughout an organization rather than centralized in a purchasing department. In fact, purchasing departments play a minor role in the procurement of knowledge services. Personnel scattered throughout an organization manage the majority of these relationships. A study performed by the Center for Advanced Purchasing Studies (CAPS) found that purchasing departments handle only twenty seven percent (27%) of service dollars spent. Projects utilizing knowledge services originate from individuals throughout an organization. In most cases the individuals responsible for these relationships lack the experience, time or resources to perform sufficient due diligence when selecting providers of knowledge services. This inexperience leads directly to cost overruns, delays, failed projects, and other problems.

One factor that contributes to this inexperience among persons within the organization is that, generally speaking, knowledge services are difficult to define. That is, knowledge services do not possess easily quantifiable characteristics. For example, knowledge services cannot be characterized by height, width, and composition. In most instances the objectives and scope of service projects are unique and change continually throughout discussions between clients and service providers. This makes it difficult to define and estimate the costs of service projects.

Selecting service providers is difficult because the evaluation of their skills is difficult. An efficient and thorough assessment of knowledge, skills and capabilities of a service provider is critical when selecting service providers. Assessments of this type are very subjective and susceptible to error.

New relationships are routinely formed. Because knowledge services needs are very diverse, client organizations cannot rely on a limited number of sources. Client organizations must continually evaluate new sources of knowledge services and transfer knowledge about current and past projects to new service providers.

Measurement of relationships is difficult. In material-oriented procurement, supplier performance measures like quantity, quality, cost, and timeliness of delivery are precisely quantified and captured in a procurement system. Measures for knowledge services can be very different for each project. Not only are measurements for knowledge services difficult to calculate, but they can be very subjective. This complexity prevents most organizations from developing a performance measurement system for service providers.

For the buyers of services, an important distinction between service providers is the nature and extent of each firm's expertise. Using conventional procurement systems (e.g., systems designed to management procurement of material) to source and manage knowledge services would be analogous to hiring a candidate for an executive position because the person would accept the lowest starting salary and had the earliest available start date without close examination of the candidate's resume or conducting an interview!

Because procurement of knowledge services amounts to tens of millions of dollars in most large and mid-size organizations, and these projects are often of strategic importance to the organization, the effect of poor information leading to the selection of an inappropriate service provider can be substantial.

Accordingly, the inventor has realized that a need exists for a system to manage knowledge based service transactions and, more particularly, for a system for managing information communicated between customers and providers of knowledge based services.

### SUMMARY OF THE INVENTION

The above and other objects are achieved by a system and method for managing service transactions and, particularly, knowledge service transactions. In one embodiment, the method includes defining a project including a plurality of activities and qualifications and preparing a Request for Proposal (RFP) from the project definition. A plurality of service providers are notified of the RFP. Proposals are received from prospective service providers. The received proposals are ranked based on evaluations of the proposal and past performance of the prospective service providers. In one embodiment, the evaluations include weighted categories of activities and qualifications of the service providers, where the weight is a percentage value corresponding to a relative importance of the activities and qualification to the project.

The method further includes selecting at least one of the prospective service providers to perform the project, negotiating terms of performance with the prospective service providers, monitoring performance of the project and, upon completion of the project, requesting evaluations of the performance.

In one embodiment, the step of defining the project includes reviewing a library of templates having a plurality of predefined project definitions, selecting a template from the library that corresponds to the project and modifying the predefined project definition to represent the project.

In another embodiment, the step of defining the project includes selecting an organizational goal (e.g., cost reduction, product innovation) that the project supports the organization in achieving.

In yet another embodiment, the step of defining the project includes creating specific measurable project objectives (e.g., return on investment of twenty-five thousand dollars ($25,000 USD), or increase customer satisfaction by twenty-five percent (25%)) that the project and service provider must achieve to be deemed a successful project and service provider performance by the client.

In still another embodiment, the step of ranking the received proposals includes evaluating past performance of the prospective service providers in terms of historical internal performance (e.g., performance of services for other clients with an organization) and evaluating past performance of the prospective service providers in terms of historical external performance (e.g., performance of services for all clients within the system).

In yet another embodiment, the step of selecting a prospective service provider includes inputting values within a range of values for performance evaluation variables and performing Monte Carlo analysis for estimating performance of one or more of the prospective service providers.

### BRIEF DESCRIPTION OF THE DRAWINGS

The features and advantages of the present invention will be better understood when the Detailed Description of the Preferred Embodiments given below is considered in conjunction with the figures provided, wherein:

FIG. 1 is a simplified block diagram illustrating components of a process and performance management system configured and operating in accordance with one embodiment of the present invention;

FIG. 2 is a block diagram illustrating relationships of users (e.g., clients and service providers) of the system of FIG. 1;

FIG. 3 is a simplified block diagram of exemplary knowledge based services;

FIG. 4 is a simplified block diagram of a template library and components of templates stored therein, in accordance with one embodiment of the present invention;

FIG. 5 is a flow diagram illustrating one embodiment of a method for defining templates;

FIG. 6 is a flow diagram illustrating one embodiment for defining a project;

FIGS. 7A-7G illustrate screen images of dialogs for defining a service project using templates in accordance with one embodiment of the present invention;

FIGS. 8A and 8B illustrate a processes wherein a client identifies service providers that receive a request for performing a service project, in accordance with one embodiment of the present invention;

FIG. 8C illustrates a screen image of a dialog for identifying services providers that receive a request as described in FIGS. 8A and 8B;

FIG. 9 illustrates a screen image of a dialog for displaying projects and their current status in accordance with one embodiment of the present invention;

FIG. 10 illustrates an interactive process by which service providers review and submit proposals for performing a requested service project and where clients evaluate and select service providers;

FIGS. 11A-11I illustrate screen images of dialogs for defining and submitting a proposal in accordance with one embodiment of the present invention;

FIGS. 12A-12C illustrate screen images of dialogs for reviewing and approving proposal information in accordance with one embodiment of the present invention;

FIGS. 13A and 13B illustrate screen images of dialogs for scoring service provider proposals based upon provider evaluation criteria and the presentation of scores for service provider proposals;

FIGS. 13C and 13D illustrate a process by which qualitative information is aggregated throughout the system of FIG. 1, in accordance with one embodiment of the present invention;

FIG. 14A illustrates a screen image of a report provided to graphically compare qualitative information corresponding to service providers and their proposals in accordance with one embodiment of the present invention;

FIG. 14B illustrates a screen image of a report provided to graphically compare cost information corresponding to service provider proposals;

FIG. 15 is a flow diagram illustrating one embodiment of a method for creating and negotiating contracts;

FIG. 16A is a flow diagram illustrating one embodiment of a method for managing projects in accordance with one embodiment of the present invention;

FIG. 16B illustrates a screen image of a dialog for updating status of a current project in accordance with one embodiment of the present invention;

FIG. 17A is a flow diagram illustrating one embodiment of a method for measuring performance data in accordance with one embodiment of the present invention;

FIG. 17B illustrates a screen image of a dialog for providing feedback regarding a completed project in accordance with one embodiment of the present invention;

FIG. 18 is a flow diagram illustrating one embodiment of a method for developing information for analyzing project performance information, in accordance with one embodiment of the present invention;

FIGS. 19A and 19B illustrate screen images of reports provided to graphically compare enterprise level information corresponding to service providers in accordance with one embodiment of the present invention; and

FIGS. 20A-20D are simplified block diagrams of exemplary implementation strategies in accordance with the present invention.

In these figures, like structures are assigned like reference numerals, but may not be referenced in the description for all figures.

### DETAILED DESCRIPTION OF THE PREFERRED EMBODIMENTS

System Overview

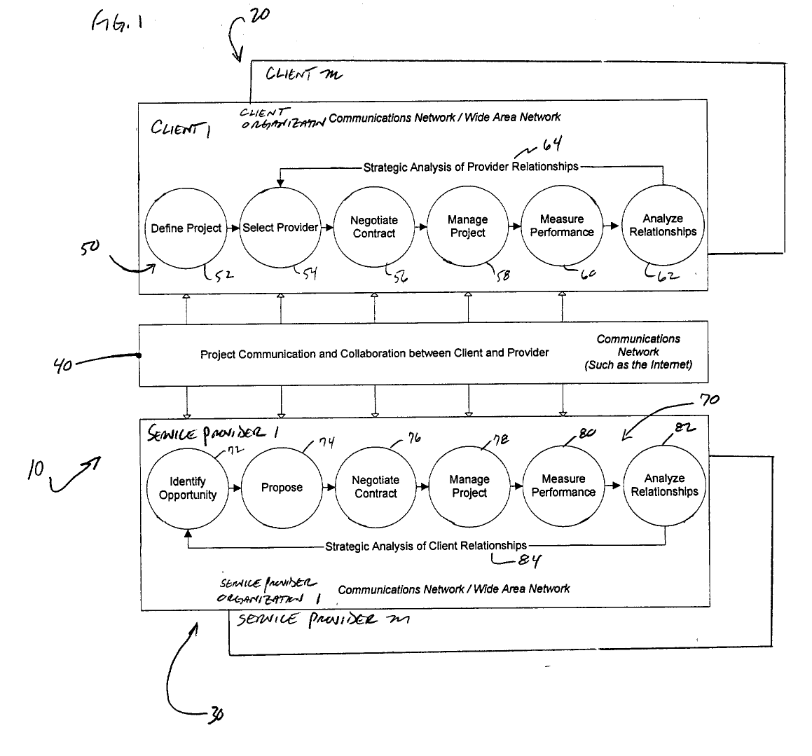

The present invention provides a complete process and performance management system, illustrated generally at 10 in FIG. 1, for knowledge services projects and relationships established between participants in project using a software application implemented over a global communications network 40 such as the Internet. Templates are developed that embody a framework for describing, processing, and managing different types of knowledge services. The templates are customized to each service and optimize the ability to communicate the complexities of a specific project (and services requested therein) and uncover the capability of a service provider for performing the work required. The templates drive the information inputs and outputs to and from clients 20 and service providers 30 throughout the life cycle of a project. In one embodiment, information from each individual project is aggregated together with all projects for analysis. The aggregated information feeds reports that describe the relationships between clients 20 and service providers 30. In one aspect of the present invention information relevant to hiring a service provider for a particular project is delivered to client personnel making hiring decisions. In another aspect of the invention information relevant to pursuing a sales opportunity with a client is delivered to service provider personnel.

The system 10 of the present invention facilitates project definition, communication of key information to internal and external parties, and the selection of a service provider. The system structures and simplifies a client's most difficult task of evaluating the knowledge and skills of service providers. This evaluation capability and the system's analysis of price and other quantitative information, gives a clear view of the information needed to make the best decision about which service provider to select. Better service providers and project processes improve service quality, eliminate cost overruns, and get projects done on time.

On every project the system 10 automatically communicates the status of cost, completion date and, importantly, risk. This gives stakeholders the insight to influence projects before they fail rather than hearing about issues after it is too late. As described herein, the inventive system 10 improves the sourcing, analysis, and strategic management of knowledge services projects and relationships.

Knowledge based services are a large part of any service economy. They include any service where a primary value received is expertise or “knowledge.” Generally speaking, knowledge services are different from other types of services where labor or infrastructure support service is the primary value received. Labor services include, for example, administrative support, contract workforce (e.g. purchasing an individual person for a period of time), janitorial, maintenance, security, temporary workers, and the like. Infrastructure support services include, for example, telephone communications, data center/hosting, data communications, and the like. Knowledge services include, for example, consulting (e.g., information technology and managerial consulting), accounting, legal, advertising, and the like. Organizations that procure knowledge services (referred to herein after generally as “client organizations”) are continuously purchasing services from organizations that provide or sell knowledge services (referred to herein after generally as “service provider organizations” or “provider organization”). These knowledge services are generally bought on a per project basis, but may also be contracted over a period of time such as, for example, on an annual basis.

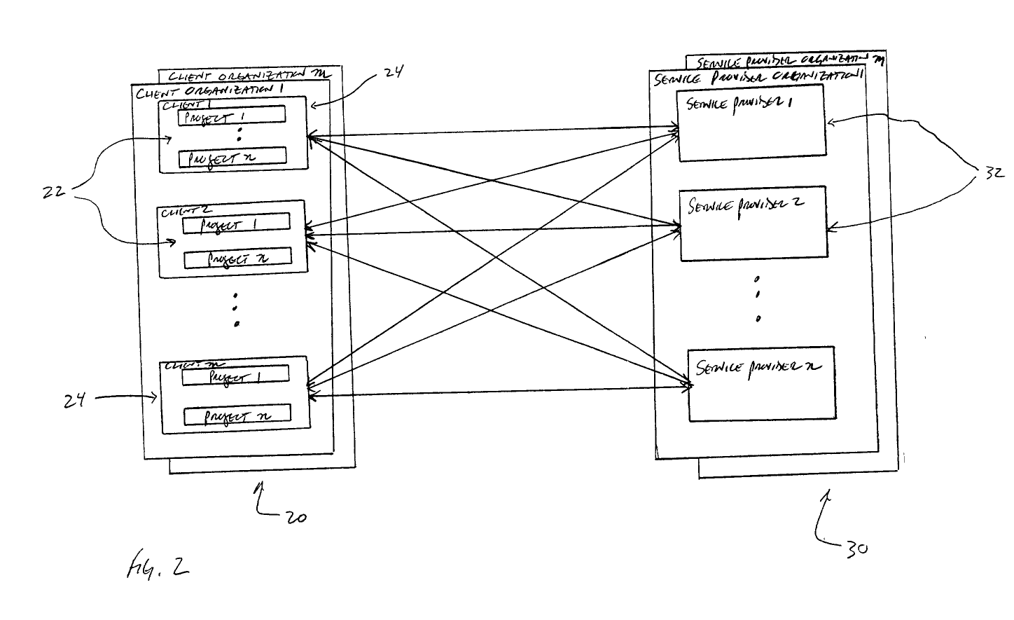

As illustrated in FIG. 2, over the course of a year numerous provider organizations 30 may perform projects, shown generally at 22, for one or more clients (e.g., managers), shown generally at 24, of a client organization 20. It should be appreciated that the clients 24 may include different individuals within a client organization 20. Each of these individual clients 24 are in charge of evaluating and hiring service providers, shown generally at 32, of provider organizations 30 for a particular project and for managing that project to its completion. As shown in FIG. 2, there may be numerous of individuals (e.g., service providers 32) in a provider organization responsible for performing knowledge services for a project 22 and client 24. The reverse is also true. For example, provider organizations 30 and providers 32 with each organization 30 may provide services to many clients 24 and client organizations 20. Therefore, an individual provider 32 may be responsible for the management of many relationships with multiple clients 24 and multiple client organizations 20.

In view of these multiple, concurrently running relationships, clients 24 throughout a client organization 20 are continuously hiring providers 32 from provider organizations 30 to perform knowledge services for their projects 22. These clients 24, in many cases, may be in different divisions, departments and geographic locations within the client organization 20. That is, the clients 24 are generally not in a purchasing department or other venue where information and/or resources are typically shared. As such, clients 24 typically have few tools or established processes to assist with any purchase decision for knowledge services. Because the clients 24 and providers 32 are so dispersed and knowledge services are so varied, much information about the relationship between the client 24 and provider 32 is inaccessible throughout the rest of the client organization 20. As a result of this dispersion, information related to the client-provider relationship is not aggregated and analyzed. This unfortunate result is further complicated by the nature of knowledge services.

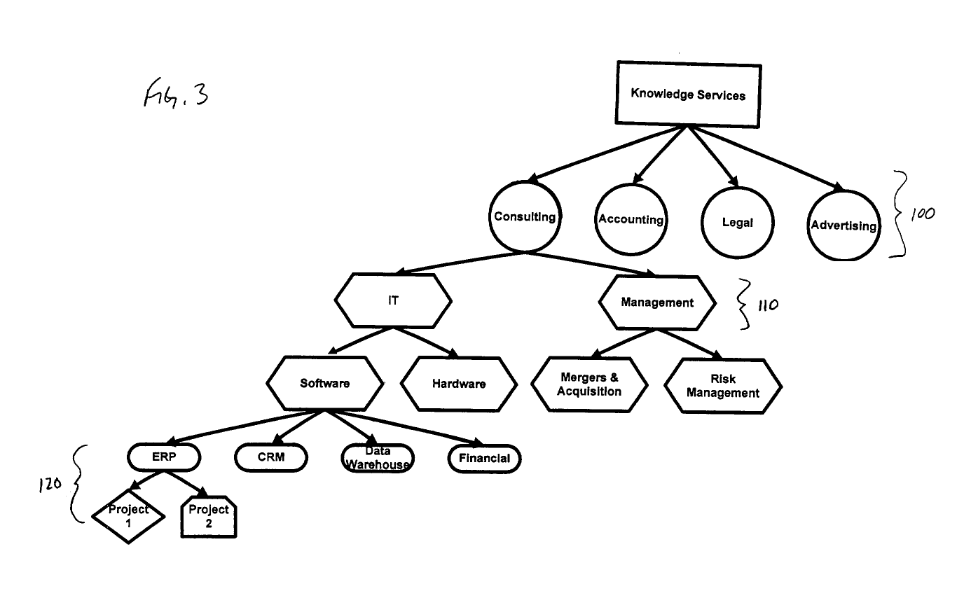

Knowledge services are very complex. For example, FIG. 3 illustrates some broad categories of knowledge services including consulting, personal legal, corporate legal, outsourcing, accounting and advertising, shown generally at 100. As can be appreciated, there are significant differences between types of services. For instance, describing an advertising project requires a “creative brief” that presents creative designs and concepts, but a legal project requires no such document.

There are also significant differences between activities and qualification for performing such activities within each of these categories of services. For example, possible branches of consulting services include information technology (IT) and management consulting, shown generally at 110. In management consulting, for example, when a client 24 is evaluating providers 32 of management services, a criterion of importance includes a background in accounting and industry experience. If a client 24 is evaluating providers 32 of IT consulting services a criterion of importance include certification and/or proficiency in specific hardware platforms and software programming languages such as, for example, Microsoft Certification and Java or Cold Fusion programming languages. Such differences in criterion for evaluating service providers can be seen at the individual project level as shown generally at 120. For instance, an Enterprise Resource Planning (ERP) software project for a service company seeking to manage human resource capabilities is significantly different from an ERP project for a manufacturer seeking to manage physical inventory and work-in-process capabilities.

It should be appreciated that the services illustrated in FIG. 3 and described above are exemplary and that it is within the scope of the present invention to provide a system for managing a number of possible services that may encompass the service industry, in general, and knowledge services, in particular. As discussed above, each service within the knowledge services market varies. The variations between types of services and projects dictate, for example:

how a service project is described;

what information is needed in a proposal;

how providers are evaluated and selected;

what terms and conditions are needed in a contract for services;

how project status is communicated;

how service provider performance is measured; and

how project success is determined.

In accordance with the present invention templates provide flexibility such that the system 10 accommodates the significant variation between projects and knowledge services. Templates include data fields for receiving information for clients 24 and providers 32 and for providing status and other processed information from the system 10 to the clients 24 and providers 32. For example and as illustrated in FIG. 4, templates include information for:

describing a service 210;

describing what processes and activities should be performed to provide the service 220;

evaluating service providers 230;

receiving proposal information 240;

specifying terms and conditions under which the service shall be performed, e.g., contract terms and conditions 250; and

determining, during and at completion, the success or failure of the project and/or activities within the project 260.

In one embodiment, templates are stored in a template library 270. As described below, the templates are retrieved from the template library 270 during processes outlined in FIG. 1.

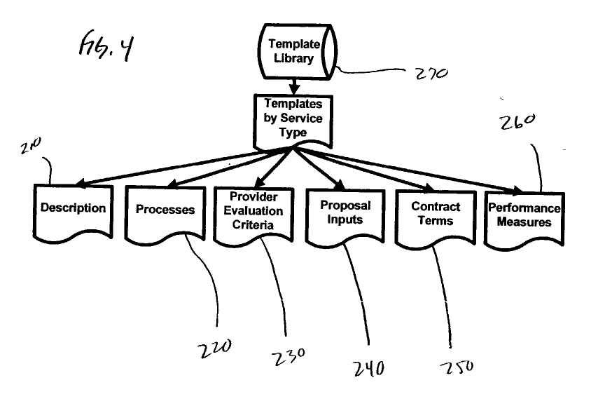

FIG. 5 illustrates a method 300 for defining templates in accordance with the present invention. As noted above, each template embodies a framework for describing and managing a different knowledge service. As such, a template is a collector of inputs and outputs, e.g., information inputs and outputs to and from clients and service providers throughout their relationship on a project. Knowledge Services are very different from one another and each requires specialized sourcing and management methods. The relevant framework for sourcing and managing different types of service projects (such as web site design, financial audits, etc.) is incorporated into a template.

Once a service is identified as requiring a template, a format is developed for presenting and storing content specific to the service. At Block 310, a client defines and describes the services required within the project. In one embodiment, the description includes, for example, fields for describing the services, scope of activities, assumptions for performing the activities within the service and specific deliverables. In one embodiment, the project definition may include identifying how the project supports or accomplishes one or more goals and/or objectives of the client organization such as, for example, advancing technology, cost control, driving innovation and improving processes. The description of services is stored in description 210 and processes 220 fields (FIG. 4).

At Block 330 of FIG. 5, a client defines and describes criterion for evaluating service providers that are engaged to perform activities within the project. The criterion includes, for example, fields for describing key criteria necessary to evaluate the skills of a service provider. As described in detail below, each criteria is assigned a weight. The weight provides an indication of the importance of a criteria as related to other criteria defined for the project. The criterion information is stored in criteria fields 230.

At Block 340, a client defines and describes quantitative information that it requires from prospective service providers when they submit proposals for providing the requested service. For example, the quantitative information includes, for example, a number of employees within the service provider organization or the number of clients that the service provider is or has provided similar services. This information is stored in proposal input fields 240.

A client defines and describes, at Block 350, terms and conditions for performing the service and activities therein for review and approval by prospective service providers. The terms and conditions are stored in contract terms fields 250. At Block 360 the client defines and describes status reporting criterion and measures by which such reporting is provided by service providers to the client. At Block 370, the client defines and describes project objectives and assigns a weighted importance of each objective that is used to measure relative success and performance of service providers. The criterion, measures and objectives information are stored in performance measures fields 260. In one embodiment, success and performance metrics include, for example, a return on investment calculation.

At Block 380, the client reviews the project definition (e.g., one or more of the definitions and criterion described above) and determines whether the project has been adequately defined. If a client wishes to add, change or delete information, the client refines one or more of the definitions and descriptions as desired. If the client is satisfied with the project definition, control passes to Block 390 where the template is stored in, for example, the aforementioned template library 270. It should be appreciate that templates can be retrieved from the template library 270 and customized by clients for specific projects. At the completion of a project, participants (e.g., clients and service providers) can evaluate the usefulness of a template on a scale of, for example, one (poor) to five (excellent) and submit suggestions for improvement to the template. Improvement can be implemented in an existing template or a new template can be created and stored in the template library 270. In one embodiment, a process for template feedback is illustrated generally at 392 of FIG. 5. The feedback process is initiated automatically at the conclusion of a project when the system 10 transmits (at Block 394) an electronic mail message to each participant of a project. At Block 395, comments including evaluations and/or suggested improvements are received from participants and the template library 270 is updated at Block 396 (e.g., an existing template is modified or a new template is stored in the library 270).

Referring again to FIG. 1, the knowledge service management system 10 facilitates and improves sourcing, analysis and strategic management of service relationships between clients 20 and providers of knowledge services 30 over a global communication network 40 such as the Internet. Clients and/or service providers initiate processes (shown generally at 50 and 70, respectively) in the system 10 that allows them to create and communicate information about individual projects and their relationship between one another.

In a client-initiated project, a client 20 selects a template from the template library 270 that is related to the project. At Block 52, the client defines the services to be performed in the project. In one example, the project may be completely and accurately defined by the selected template. In another example, the template may only generally define services with the project. As such, the client may modify the template by adding, changing or deleting information from the selected template to more accurately define the current project.

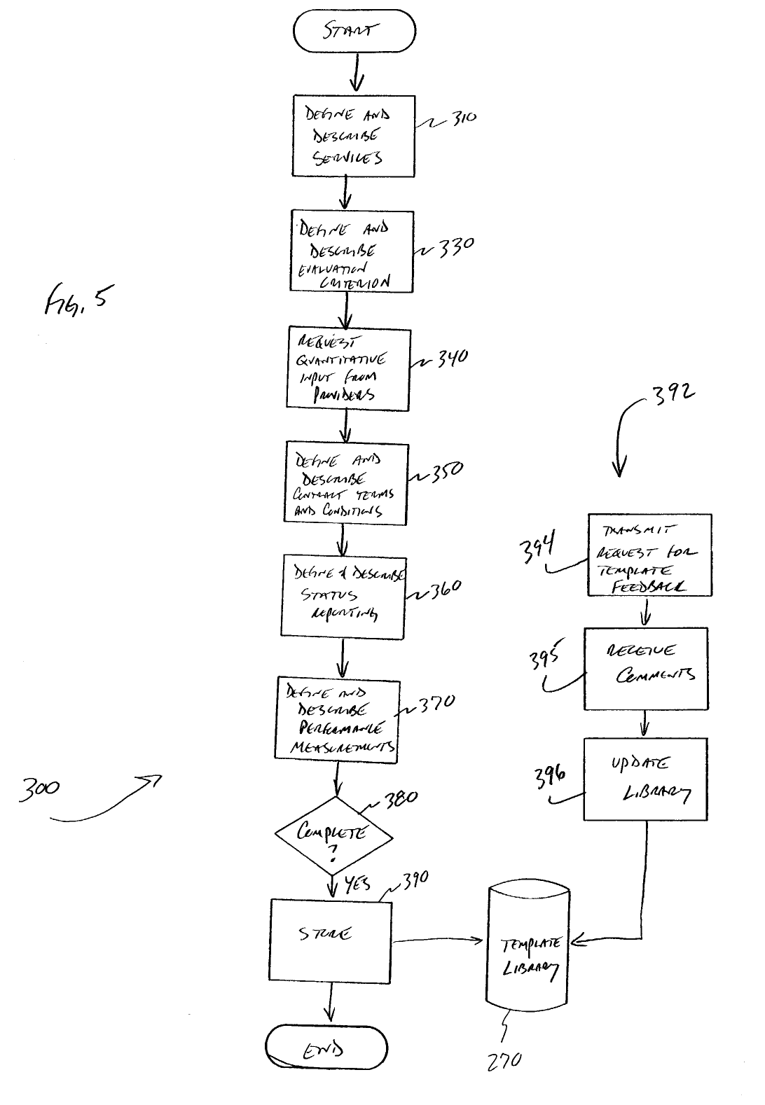

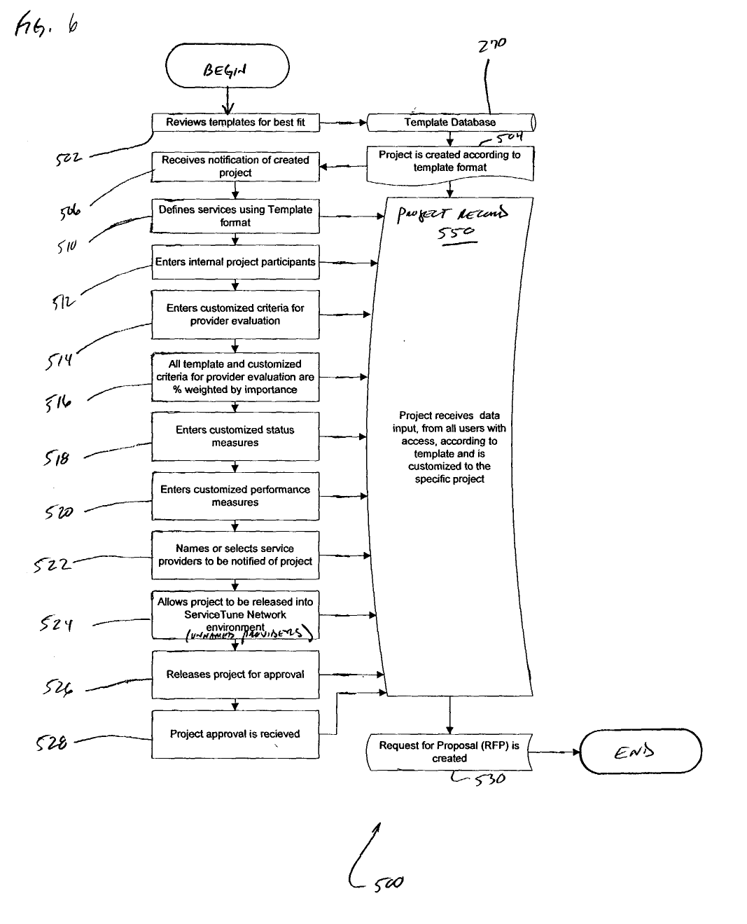

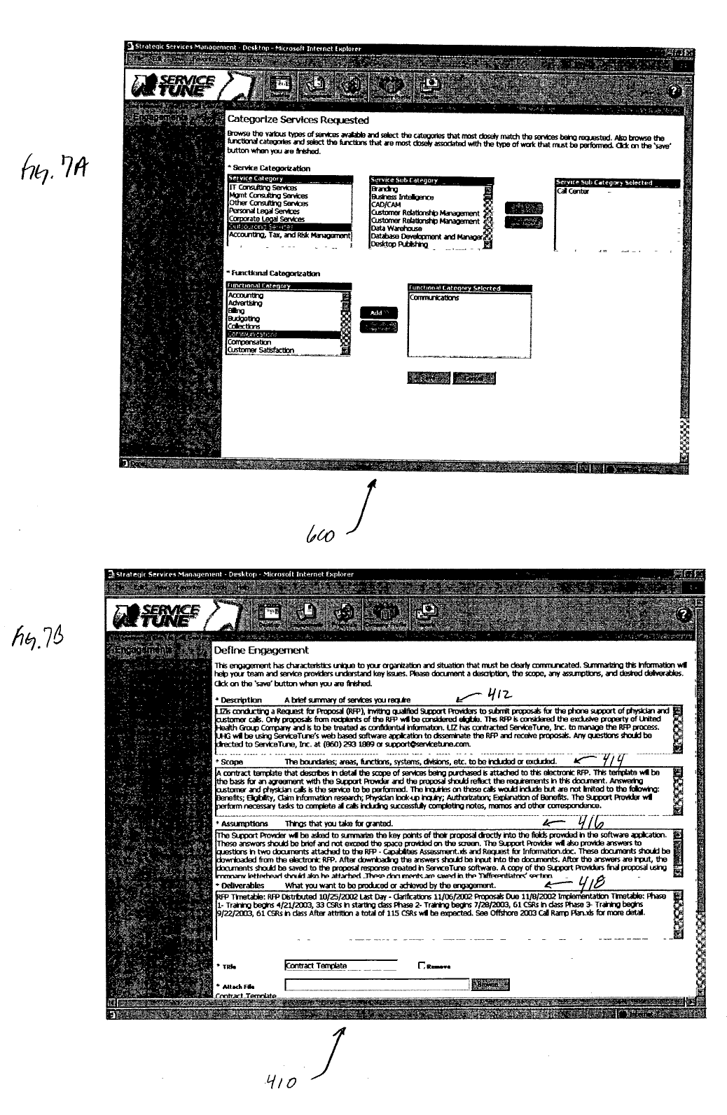

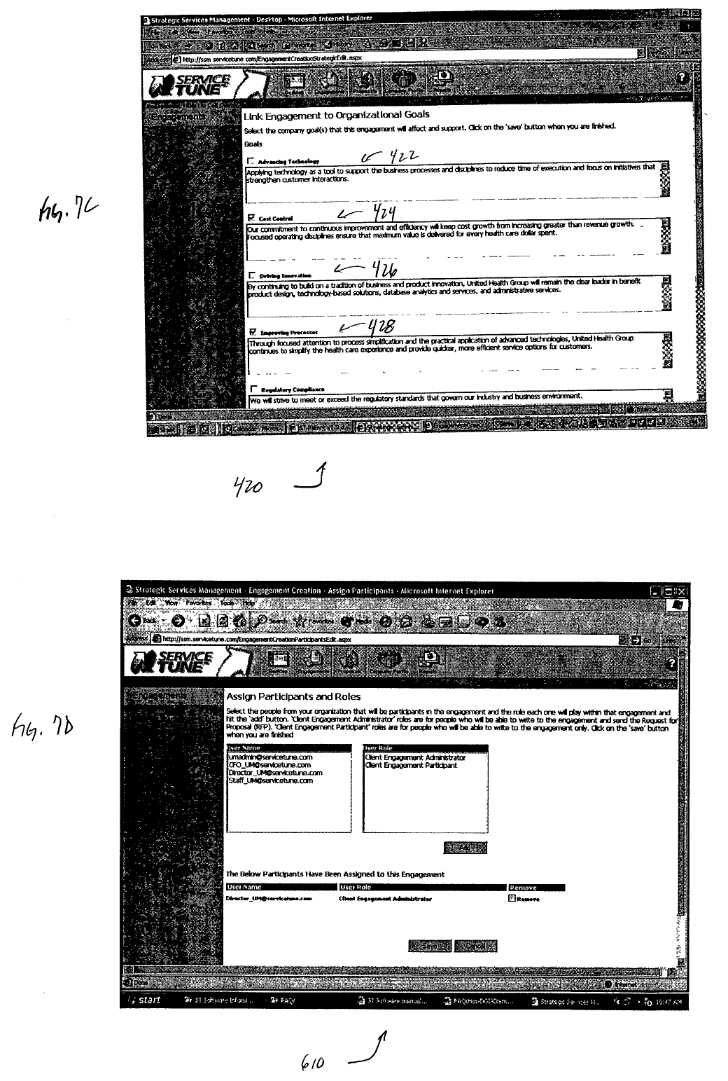

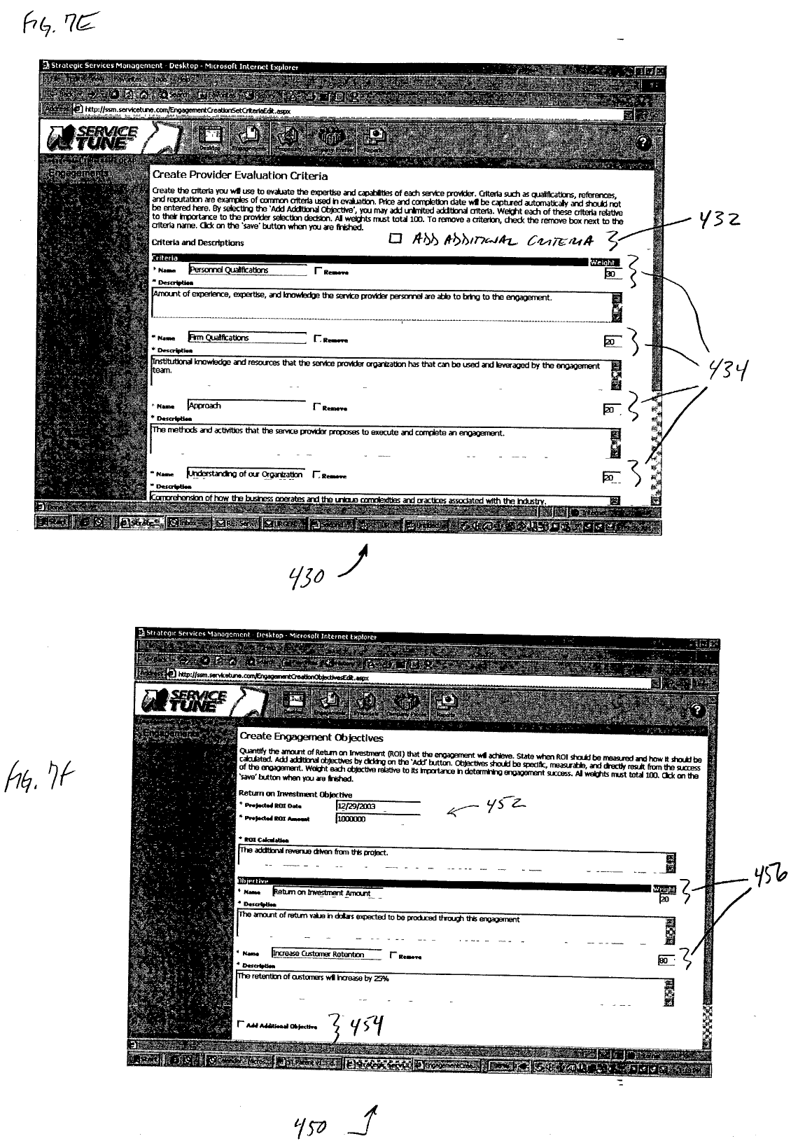

FIG. 6 illustrates a preferred method, shown generally at 500, wherein a client defines a project. At Block 502, a client reviews templates within the template library 270 and selects a template that best describes the project. In one embodiment, the system 10 presents a Categorize Services Requested dialog, shown generally at 600 in FIG. 7A, to assist in evaluating the contents of template library 270. If there is no specific template for defining the project, then a generic template is used. Once a template is selected, a project record 550 is created at Block 504 and the client is notified at Block 506. In one embodiment, the project record 550 is a computer file that contains all of information related to a project (initially as defined by the selected template). The project record 550 is stored on a storage device operatively coupled to a computer processing system executing the system 10

As noted above, templates establish a common framework that clients and service providers use when describing service projects. Once the project record 550 is created, information included in the project (e.g., copied from the selected template) may be customized by a client. For example, and as illustrated in Blocks 510 to 524, the client may customize the project by, for example:

inputting at Block 510 a description of the project using, for example, a Define Engagement dialog shown generally at 410 of FIG. 7B. The dialog 410 includes fields for describing the services 412, scope of activities 414, assumptions for performing the activities within the service 416 and specific deliverables 418. In one embodiment, the project definition may include identifying how the project supports or accomplishes one or more goals and/or objectives of the client organization. FIG. 7C illustrates a Link Engagement to Organizational Goal dialog generally at 420. The dialog 420 includes one or more goals of the organization, e.g., Advancing Technology 422, Cost Control 424, Driving Innovation 426 and Improving Processes 428, which are selectively activated and associated with a project;

identifying at Block 512 project participants using, for example, an Assign Participants and Roles dialog 610 (FIG. 7D);

creating at Block 514 project specific evaluation criteria, e.g., beyond what is provided in the selected template, for the evaluation of service providers using, for example, a Create Provider Evaluation Criteria dialog shown generally at 430 of FIG. 7E. The dialog 430 includes fields for describing key criteria necessary to evaluate the skills of a service provider. A client adds new evaluation criteria by selecting an Add Additional Criteria button shown generally at 432. As described in detail below, each criteria is assigned a weight (illustrated generally at 434). The weight 434 provides an indication of the importance of a criteria as related to other criteria defined for the project. For example, and as shown in FIG. 7E, Personnel Qualifications is assigned a weight value of thirty percent (30%) and is a relatively more important criteria than the Firm Qualifications that is assigned a weight value of twenty percent (20%);

inputting at Block 516 percentage weight of importance for all qualitative and quantitative criteria used for evaluation. In one embodiment, the system 10 presents a Create Engagement Objectives dialog, illustrated generally at 450 in FIG. 7F to assist the client describe the metrics for measuring relative success of the project. Metrics include, for example, a return on investment calculation, as shown generally at 452 in FIG. 7F. A client can add objectives by selecting an Add Additional Objectives button shown generally at 454. As shown in FIG. 7F, objectives are also assigned weights, shown generally at 456, to provide an indication of the importance of an objective as related to other objectives defined for the project;

creating at Block 518 project specific status measures, e.g., beyond what is in the selected template;

creating at Block 520 project specific performance measures, e.g., beyond what is in the selected template;

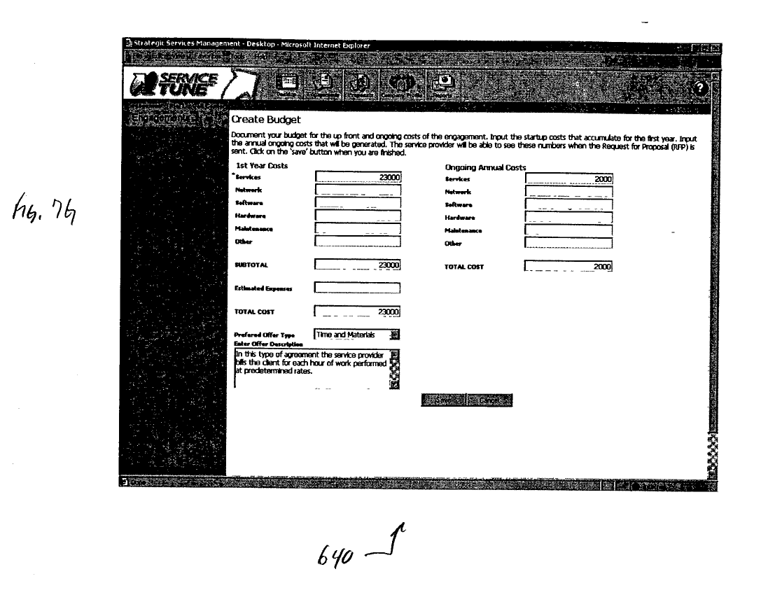

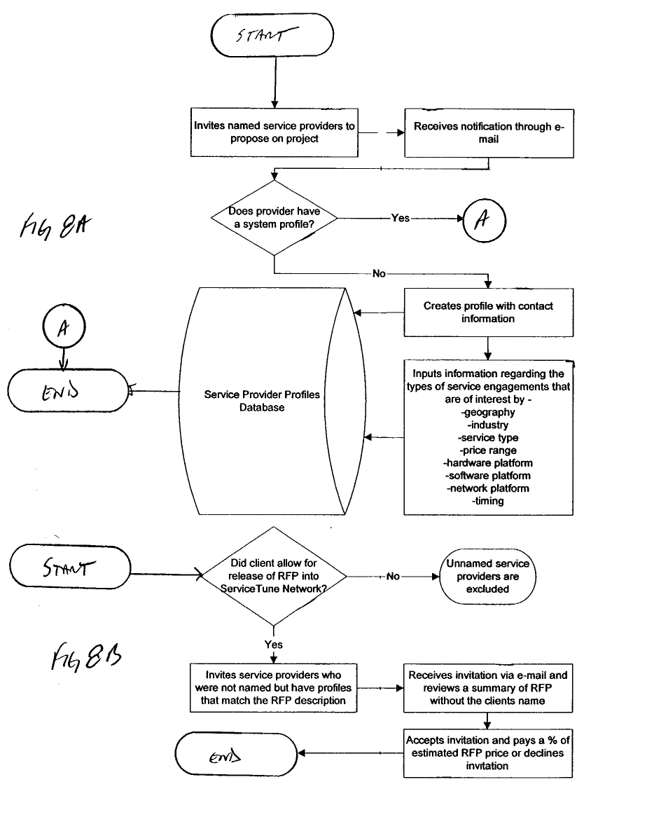

naming at Block 522 service providers to be notified of the project using, for example, a Target Service Providers dialog 620 (FIG. 8C); and

choosing at Block 524 if the project should be released to unnamed service providers that have profiles in the system 10 (as illustrated in FIGS. 8A and 8B).

As shown in FIG. 8A, if the named service provider does not have a profile inside the system 10, then the client can create one. Examples of information contained as part of the profile includes contact information such as:

name of service provider;

name of service provider organization;

address of service provider;

email address of service provider;

types of services that the provider provides;

industries that the provider serves;

functional expertise of the service provider (e.g., finance, manufacturing, human resources, etc.);

size of projects that the service provider has interest in (e.g., maximum or minimum preferred price and/or resources);

software, hardware, and network platform that the service provider specializes;

projects start and end dates that are of interest to the service provider; and

geographic location of interest to the service provider.

If the Client has indicated (e.g., at Block 524 of FIG. 6) that the RFP can be released to unnamed service providers, then it is sent to service providers that are a part of the system 10 (e.g., have profiles or otherwise registered in the system 10). In one embodiment, unnamed service providers can review and transmit proposals only to RFPs with requirements that match the unnamed service provider's profile. As shown in FIG. 8B, the RFPs received by unnamed service providers do not disclose the name of the client. In one embodiment, after reviewing the RFP, unnamed service providers must pay a percentage of the estimated RFP price to continue forward in the process and respond to the RFP (e.g., submit a proposal).

As noted above, once a client defines a project and creates an RFP from the project record 550 of an approved project (at Block 52) the client has the option to broadcast an RFP to named service providers and unnamed service providers that are a part of the communication network and have profiles inside the system that match the RFP. Service providers review the client's service needs as defined in the RFP (Block 72) and submit a proposal to perform services at Block 74. The client then selects a service provider from the received proposals at Block 54.

Referring again to FIG. 6, at Block 526 the client who initiates the project designates any project participants who must approve the project prior to release to service providers and designates any participants who must approve of the selected service provider.

The client who initiates the project also assigns the rights of each participant to view and/or edit the following components of the project record 550:

description of the project, e.g., using the Define Engagement dialog 410 (FIG. 7B) and Link Engagement dialog 420 (FIG. 7C);

project participants and the user rights of each participant, e.g., using the Assign Participants and Roles dialog 610 (FIG. 7D);

customized evaluation criteria for the evaluation of service providers, e.g., using the Create Provider Evaluation Criteria dialog 430 (FIG. 7E);

percentage weight of importance for all qualitative and quantitative criteria used for evaluation (FIGS. 7E and 7F);

project status information such as percent Complete, Total Cost, Delivery Date, Risk, date of last change, and who last changed the status;

names of select service providers to be notified of the project using, for example, the Assign Participants and Roles dialog 610 (FIG. 7D);

project budget including first year costs, annual ongoing costs, and the offer type budgetary information using, for example, a Create Budget dialog 640 (FIG. 7G); and

calendar and meeting information.

In addition, the client assigns the rights of each participant to initiate or approve the following components of the project record 550:

change orders;

bills received; and

electronic surveys to project participants.

In one embodiment, an email notification is sent (at Block 526) to any personnel who must approve the project prior to its release. Once approval is received (at Block 528), a Request for Proposal (RFP) is created (at Block 530) from the project record 550.

Once the information is entered into the project record 550 and the RFP is created the system 10 initiates a collaborative environment wherein participants manage the project lifecycle as described below with reference to other components of client and service provider processes 50 and 70, respectively.

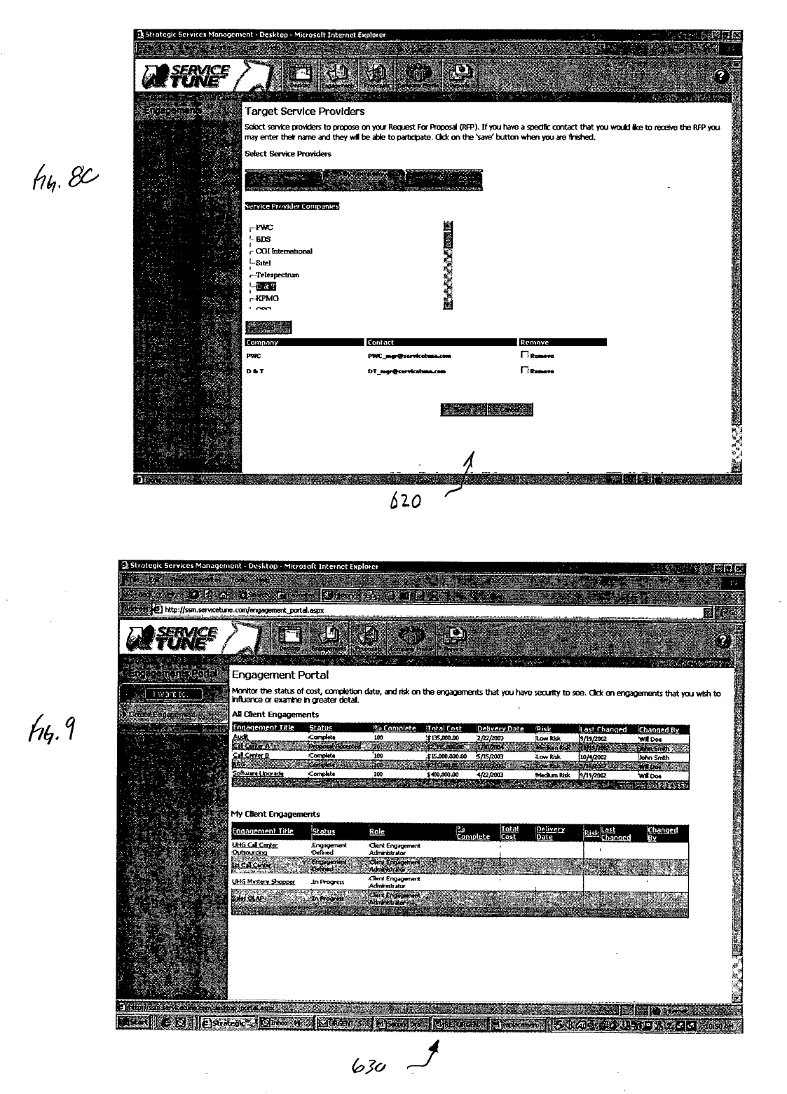

At Block 72 (FIG. 1) service providers review RFPs and identify potential project opportunities. The reviewed RFPs include ones that a service provider received specific notice of (e.g., via an email message) and ones that have been released into the system 10 and are available for review and proposal by unnamed service providers. An Engagement Portal dialog shown generally at 630 of FIG. 9 assists clients and service providers track projects and project status in the system 10.

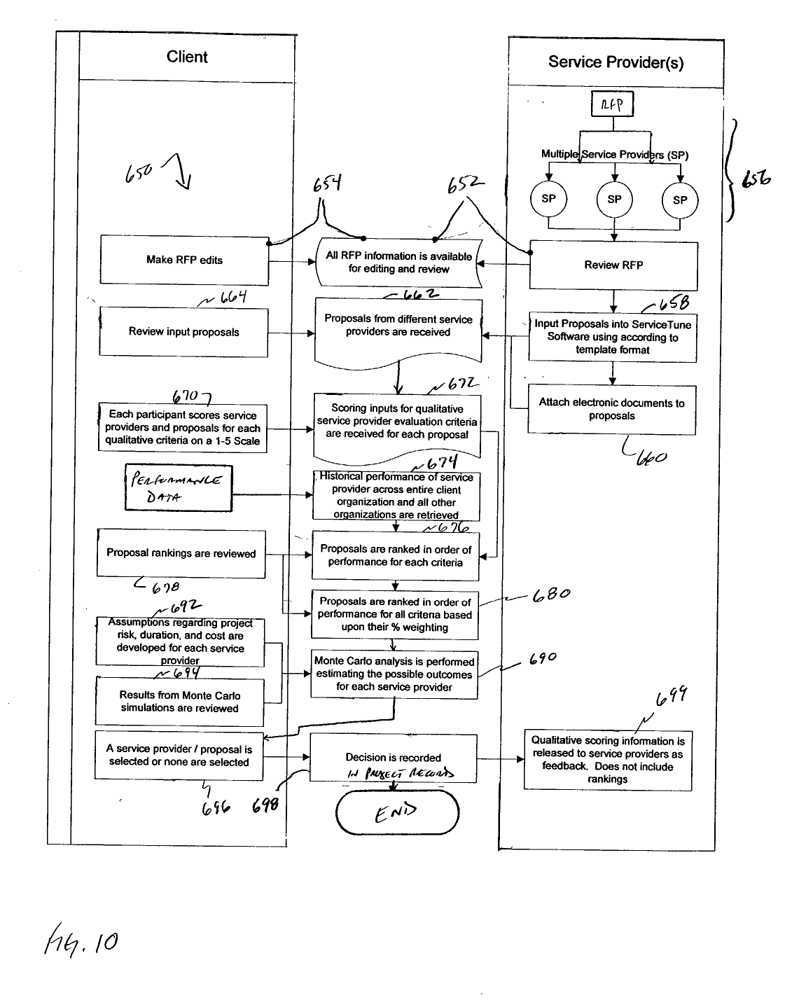

In accordance with the present invention, the system 10 fosters an interactive process (represented by Blocks 54 and 74) wherein clients evaluate the skills and knowledge of service providers and service providers modify proposal information such that it accurately defines the parameters by which they shall perform the engagement. FIG. 10 depicts this interactive review and evaluation process generally at 650. Skill evaluations are presented in context with proposal information (defined at Block 52) and information about historical performance of the service provider internal to the client organization and from other client organizations using the system 10 (information provided at the end of projects as illustrated at 64 and 84 of FIG. 1).

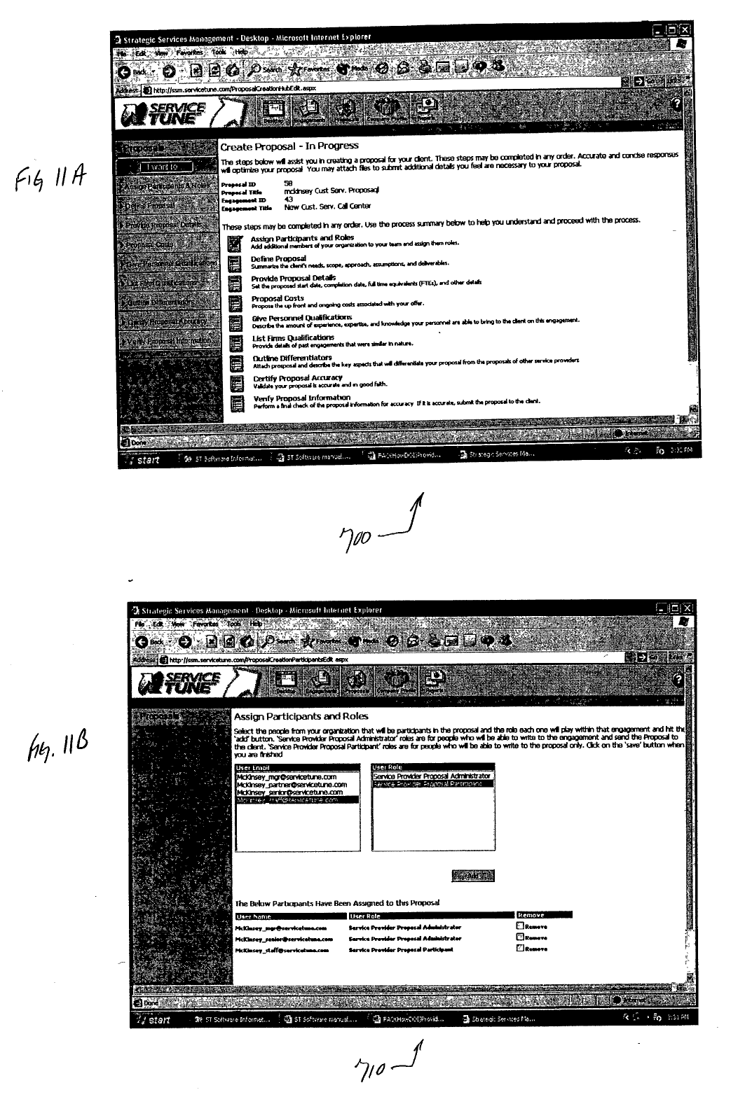

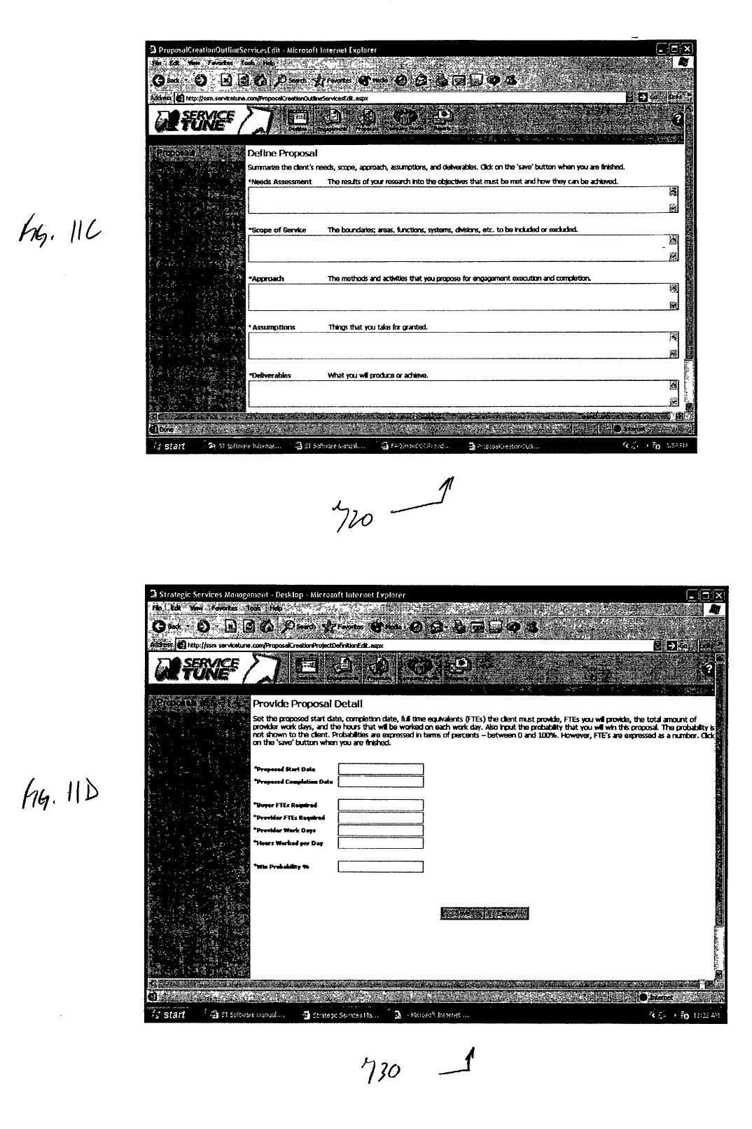

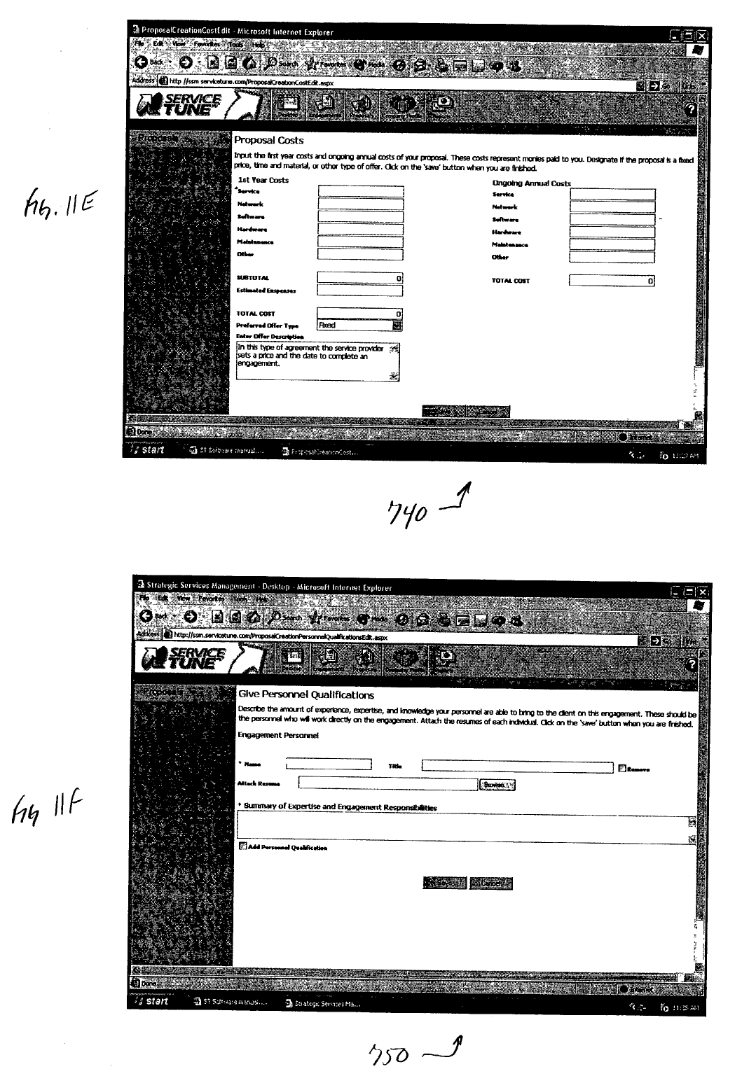

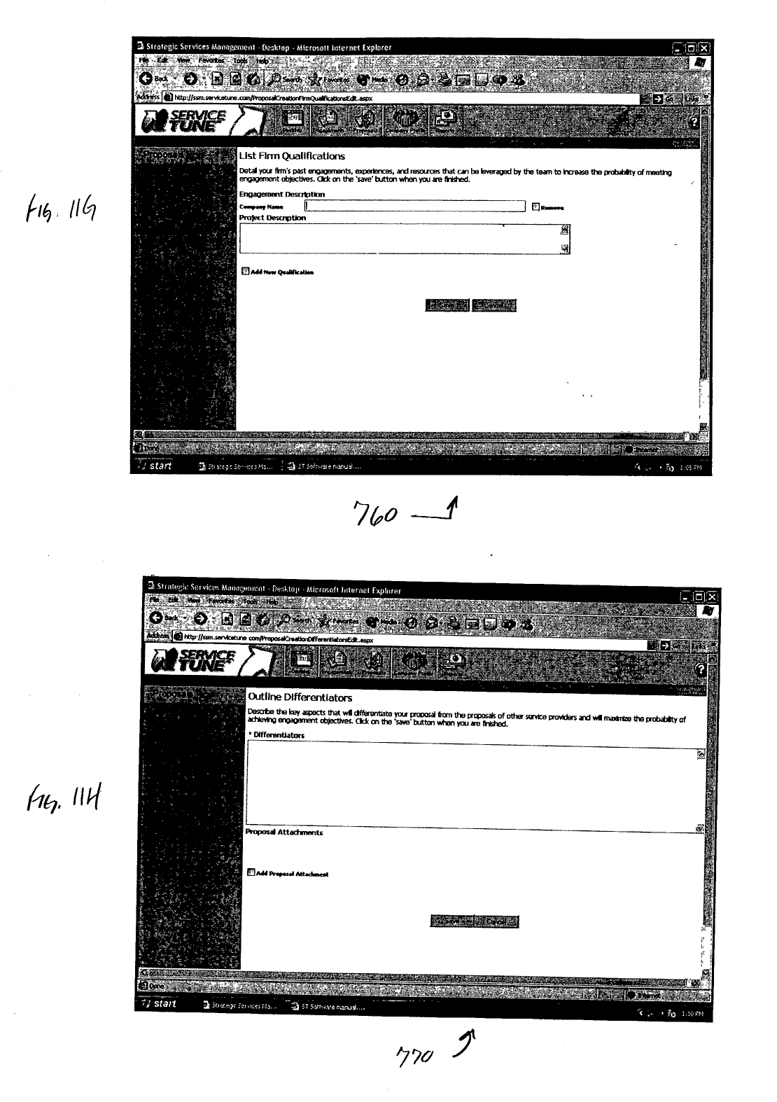

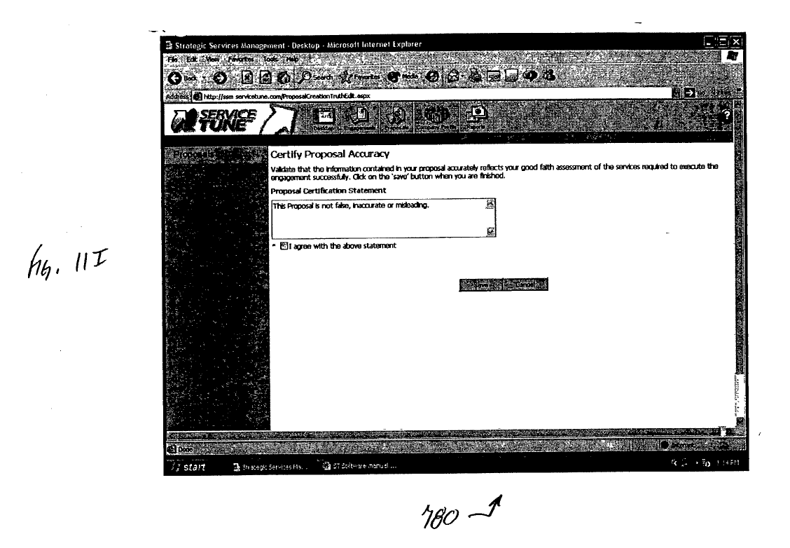

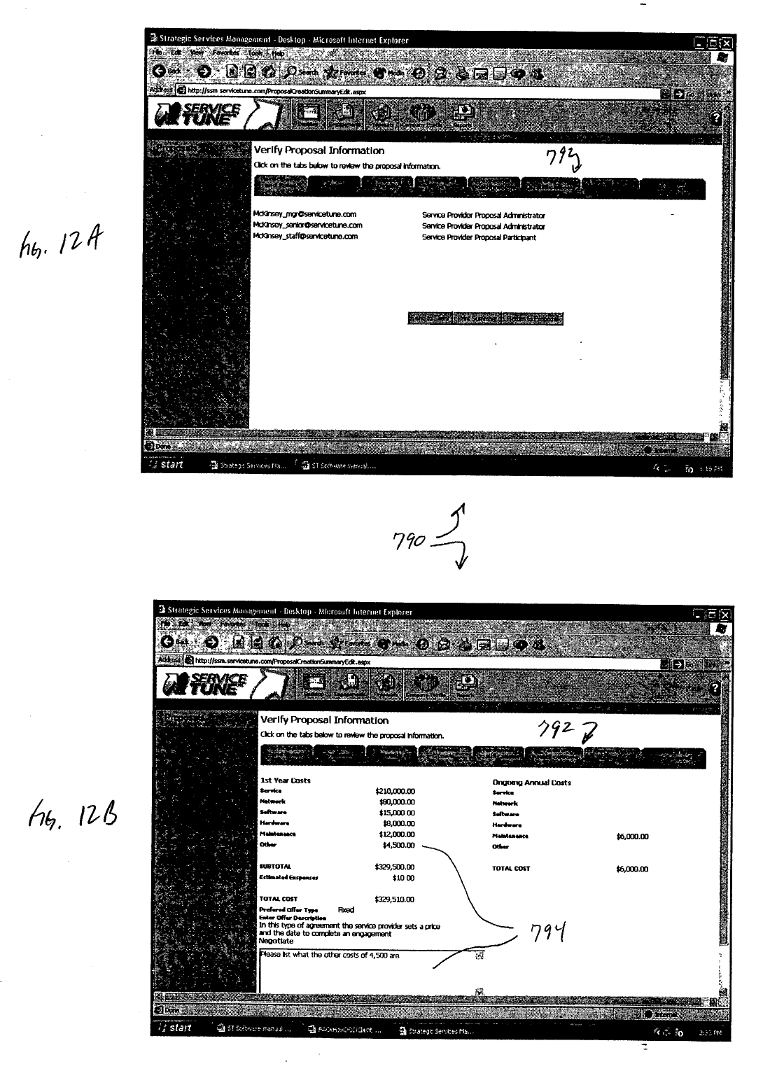

As shown in FIG. 10, RFP information is available for review and modification by service providers at 652 and clients at 654. The system 10 provides a framework for multiple service providers to receive an RFP (shown generally at 656 of FIG. 10) and respond with a proposal that fulfills the requirements defined in the RFP. In accordance with the present invention, the system presents a series of dialogs (described below) such that service providers utilize a template format to define a proposal for providing services to satisfy the RFP at Block 658 (similar to how the clients used templates to define the project and create the RFP). FIG. 11A depicts a Create Proposal dialog, generally at 700, that provides a platform for service providers to review RFP requirements and create a proposal in response thereto. The proposal information includes, for example:

the provider's participants who perform activities specified within the proposal inputted by the service provider using, for example, an Assign Participants and Roles dialog shown generally at 710 in FIG. 11B;

proposal definition including a needs assessment, scope of services, approach, assumptions and deliverables inputted by the service provider using, for example, a Define Proposal dialog shown generally at 720 in FIG. 11C;

proposal details including the start date, completion date, provider full time equivalents (FTE) (e.g., personnel equivalents), client full time equivalents, work days, hours worked per day, and percent of winning the project (e.g., probability that will be awarded the service contract) inputted by the service provider using a Provide Proposal Detail dialog shown generally at 730 of FIG. 1D;

proposal costs including first year costs and annual ongoing costs and type of offer inputted using a Proposal Costs dialog shown generally at 740 of FIG. 11E;

personnel qualifications including the title and experience of the each person inputted using a Give Personnel Qualifications dialog shown generally at 750 of FIG. 11F;

firm qualifications including similar companies and a description of the work performed at those companies inputted using a List Firm Qualifications dialog shown generally at 760 of FIG. 11G;

differentiators and file attachments inputted using an Outline Differentiators dialog shown generally at 770 of FIG. 11H; and

certification of proposal accuracy inputted using a Certify Proposal Accuracy dialog shown generally at 780 of FIG. 111.

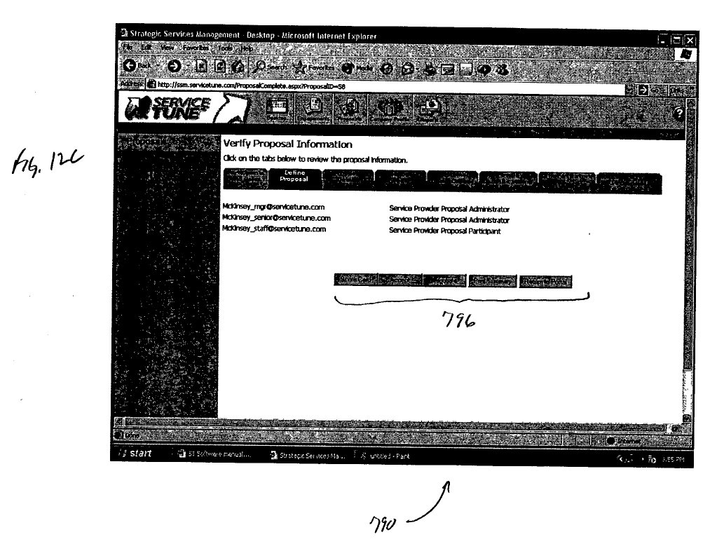

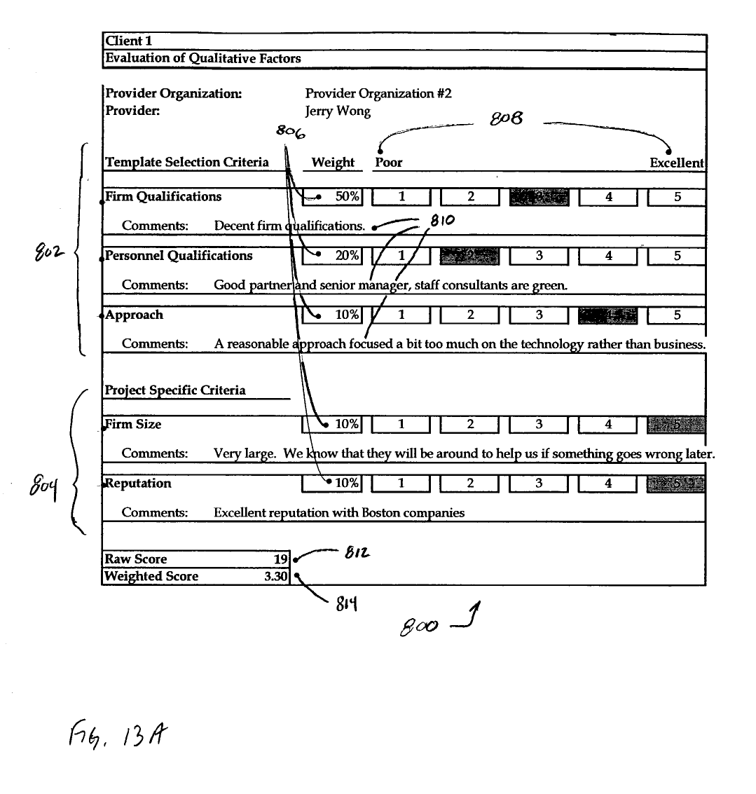

As noted above, service providers 32 enter the preceding information about their proposal into an electronic proposal form. At Block 660, service providers may also add file attachments to their proposal submission. At Block 662 client organizations 20 receive proposals from multiple service provides and review (at Block 664) the proposals. It should be appreciated that the system 10 provides a framework for receiving and evaluating the multiple proposals and provider organizations that have submitted proposals. FIGS. 12A, 12B and 12C depict a Verify Proposal dialog, generally at 790, wherein information within the proposal can be reviewed. In one embodiment, the dialog 790 includes tabs 792 that selectively display proposal information.

One aspect of the review and evaluation of a proposal is a consideration of pass performance by service providers 32 both to the client 24 tending a current RFP and to other clients and client organizations 20 utilizing the system 10. As noted above, feedback is requested of all participants of a project at the end of the project. The feedback is recorded and processed (as described below) so that qualitative criteria is available to objectively evaluate service providers 32 (e.g., at Blocks 62 and 64, and 82 and 84 of FIG. 1). As such, multiple clients are able to measure service provider organizations 30 and their proposals.

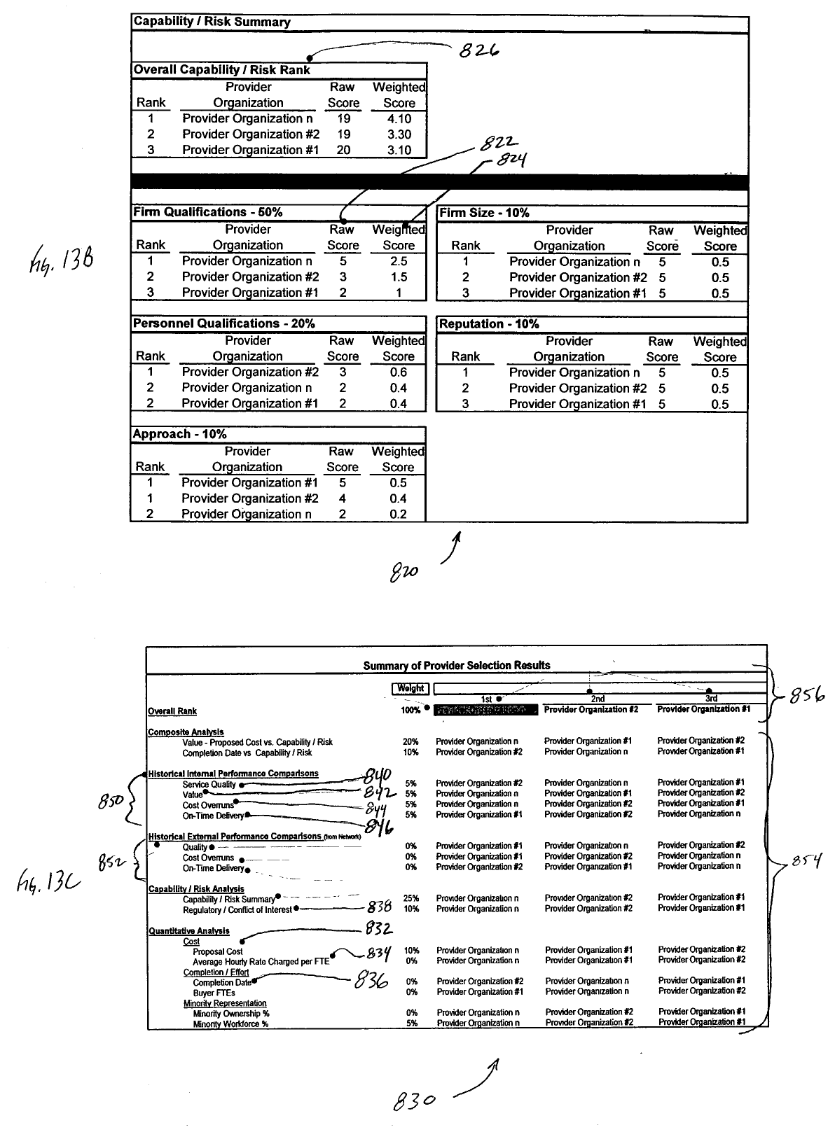

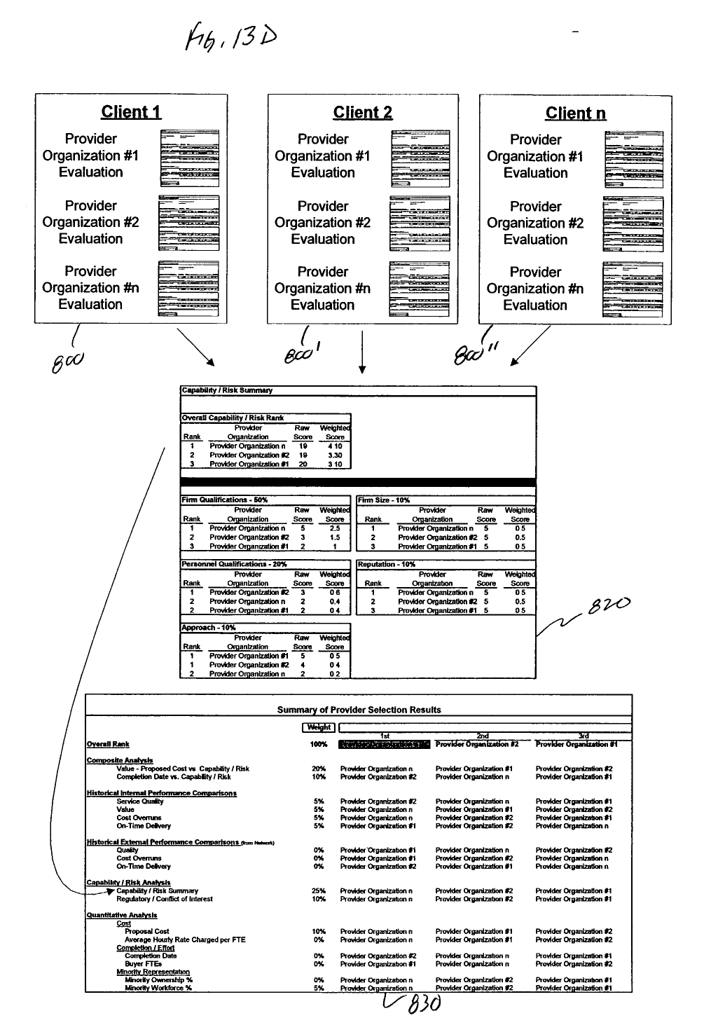

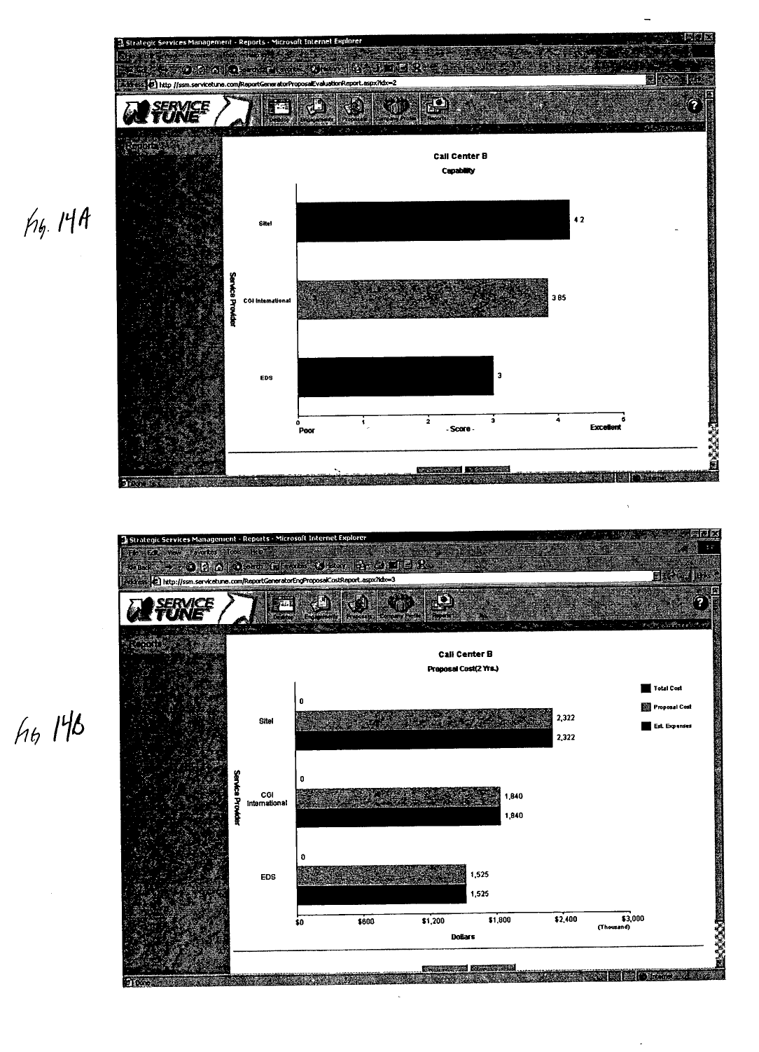

FIG. 13A illustrates an example of a form, shown generally at 800, clients 24 use to evaluate service providers 32. The form 800 includes qualitative criteria contained in the template at 802 as well as project specific criteria at 804. The project specific criteria were created as part of the project definition (at Block 52 of FIG. 1). Percentage weights 806 were also assigned to all criteria as part of the project definition at 434 and 456 of FIGS. 7E and 7F, respectively. Measurements are included (at 808) of the service provider organizations on, for example, a one (1, representing “poor”) to five (5, representing “excellent”) point scale. A client 24 selects one of the measurements 808 (e.g., one to five) to assign a value to the criteria. Additionally, clients may input comments at 810. FIG. 13A depicts the evaluation criteria as including: firm qualifications; personnel qualifications; and approach. The criteria also includes project specific criteria such as: firm size; and reputation. It should be appreciated that if the template selected had been for purchasing another type of service, the template criteria 802 would have been different. For example, if the template selected had been for purchasing legal services different qualitative criteria that would appear such as, for example: trial experience; and quality of paralegal department. In another example, if the template selected had been for purchasing advertising services different template criteria that would appear such as, for example: creativity; electronic media capability; and print media capability.

As illustrated in FIG. 13A, a raw score is included at 812 of the form 800. The raw score 812 is the total of all the points received by the service provider organization 30 on that form from the client 24. A weighted score is also included at 814 on the form 800. The weighted score 814 is the total of all the weighted points received by the service provider organization on that form from the client. Weighted points 814 are calculated by taking the score received for a particular criteria multiplied by the weight of that criteria. For example, a weighted score for the Firm Qualifications criteria illustrated in FIG. 13A equals one and one half (1.5), calculated by multiplying a raw score of three (3) by the weighting of fifty percent (50%).

The forms (such as form 800) completed by each client 24 to evaluate each service provider organization 30 are summed together by the system 10 to permit an overall capacity versus risk analysis of service providers 32 (at Blocks 672, 674 and 676 of FIG. 10). FIG. 13B illustrates a Capability/Risk Summary form generally at 820 wherein the raw scores at 822 are an average of the total points awarded to each service provider organization by each client. Weighted scores at 824 are an average of the total points awarded to each service provider organization 30 by each client 24 multiplied by the weight of the particular criteria. The Overall Capability/Risk Rank shown at 826 is a ranking of the service provider organizations based upon the weighted score 824. For example, the Rank 826 is a summation of the raw scores 822 and weighted scores 824 of each criteria in the Capability/Risk Summary form 820. The highest rank, e.g., one (1), goes to the highest weighted score. This method of ranking criteria attributes is generally referred to as Multi-Attribute Utility Theory to those in the art.

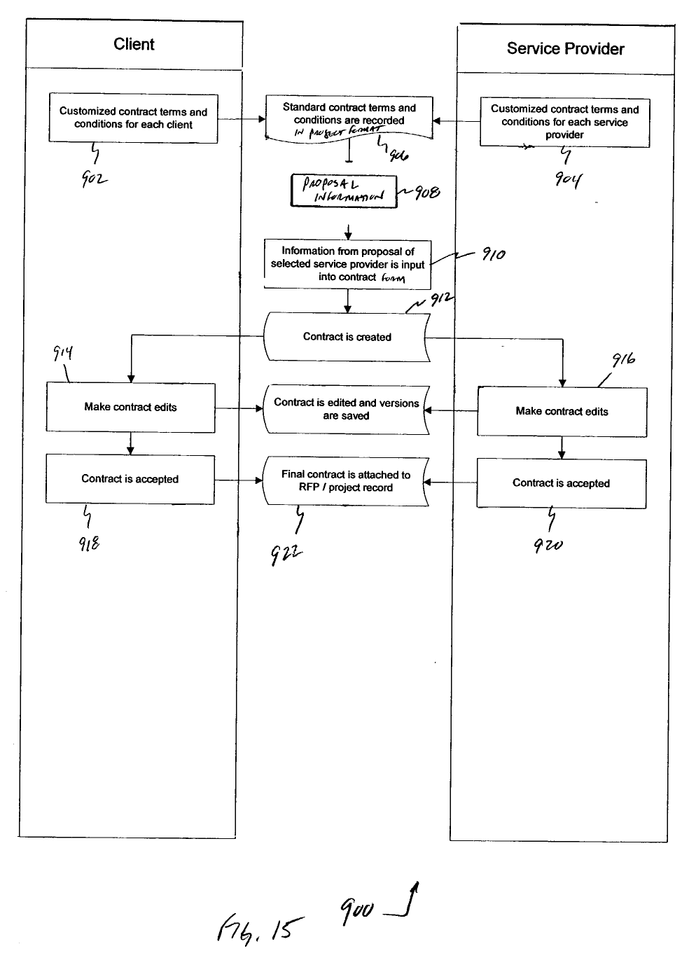

The Overall Capability/Risk Ranks 826 are incorporated into a Summary of Provider Selection Results form shown generally at 830 in FIG. 13C. The Summary form 830 illustrates provider organization ranking in predetermined categories and overall. FIGS. 14A and 14B illustrates these rankings graphically in report formats.

An overview of the flow of electronic forms 800 (FIG. 13A) completed by the clients to the Capability/Risk Summary form 820 (FIG. 13B) to the Summary of Provider Selection Results form 830 (FIG. 13C) is illustrated in FIG. 13D.

The Summary of Provider Selection Results form 830 (FIG. 13C) includes additional analytical rankings performed by the system 10. Some of the key analytical rankings and a description of their calculation include:

proposal cost 832, which is a ranking with lowest result receiving the highest rank, where proposal cost=(cost of services personnel) plus (estimated expenses), as shown graphically in FIG. 14B;

average hourly rate charged per full time equivalent (FTE) 834, which is a ranking with lowest result receiving the highest rank, where average hourly rate charged per FTE=(cost of services personnel) divided by (proposed hours of work);

completion date 836, which is a ranking with lowest result receiving the highest rank, where completion date=(number of days of project) minus (before/after client specified completion date);

regulatory/conflict of interest 838, which is a ranking with highest result receiving the highest rank, where regulatory score=one (1) if the Service Provider Organization is the independent auditor and the project is not for annual audit services to five (5) if the service provider organization is not the independent auditor;

service quality 840, which is a ranking with highest result receiving the highest rank, where service quality=(sum of all points received on quality surveys for a service provider organization within the client organization) divided by (number of quality surveys performed (quality surveys are discussed in detail below));

value 842, which is a ranking with highest result receiving the highest rank, where value=(average service quality) divided by (average hourly rate charged per FTE);

cost overruns 844, which is a ranking with lowest result receiving the highest rank, where cost overrun score=(percentage of projects performed for a client organization by a service provider organization that were above the originally proposed cost) multiplied by (average percentage of increase in cost above the originally proposed costs of projects performed for the client organization by the service provider organization); and

on-time delivery 846, which is a ranking with lowest result receiving the highest rank, where on-time delivery score=(percentage of projects performed at a client organization by a service provider organization that were delivered after the proposal date) multiplied by (average percentage of increase in work days beyond the originally proposed delivery dates of projects performed at the client organization by the service provider organization).

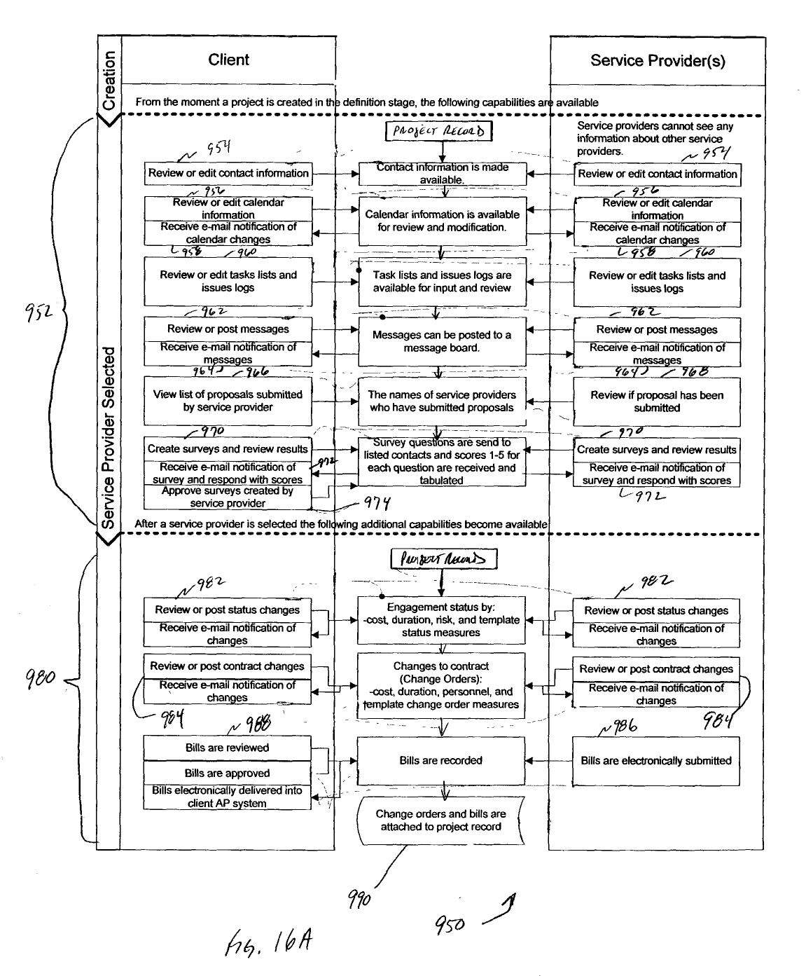

As illustrated in Summary form 830 (FIG. 13C), the analytical ranking data includes both data from within the client organization (e.g., the Historical Internal Performance Comparisons shown generally at 850) and data from other client organizations within the system 10 (e.g., Historical External Performance Comparisons shown generally at 852). It should be appreciated that the external performance comparisons are calculated in substantially the same manner as the internal comparisons described above. The differences being that the external comparisons include data from all client organizations in the system 10 as opposed to data within only one client organization as with the internal comparisons. Referring again to FIG. 10, at Blocks 678 and 680 the ranking data is compiled and service providers 32 and incoming proposals are displayed by, for example, their respective rank with each predetermined criterion shown generally at 854 (FIG. 13C). Using the aforementioned Multi-Attribute Utility Theory, an overall rank shown generally at 856 (FIG. 13C) is calculated based upon the percent weight of each criteria, as specified during project definition, and individual rank for each criteria. The difference between this calculation and the one for the Overall Capability/Risk Ranks (shown at 826 of FIG. 13B) is that the raw score is multiplied by the percent weight. The raw score is determined based upon the rankings for each analysis criteria. The highest ranked service provider organization gets a raw score equal to the amount of service provider organizations being evaluated (x), the second ranked service provider organization gets a raw score equal to x−1, and so on. In FIG. 13C, for example, the raw score for service provider organization n for the Proposal Cost rankings 832 is three (3) because there are three service provider organizations displayed and the highest ranked service provider organization gets a raw score equal to the total amount of service provider organizations being evaluated. Also, in the example illustrated in FIG. 15C, service provider organization 1 receives a raw score of two (2) and service provider organization 2 receives a raw score of one (1) for the Proposal Cost ranking 832.

The raw scores for the Proposal Cost 832 and other rankings are multiplied by the percent weight of each individual ranking criteria, e.g., ten percent (10%) for the Proposal Cost 832 depicted in FIG. 13C. These calculations are summarized to provide the Overall Rank 856 for the Summary of Provider Selection Results form 830 (FIG. 13C). In effect, the Overall Rank 856 is the recommendation made by the system 10 for the service provider 32 that statistically is the best suited to perform the requested service, e.g., the service provider 32 to which the system 10 recommends the client 24 enter contract negotiations.

In accordance with one aspect of the present invention, a client 24 performs Monte Carlo analysis (at Block 690 of FIG. 10) for estimating performance of one or more service providers. That is, the client inserts value ranges for performance variables (e.g., the categories of criterion illustrated in FIG. 13C) of service provider organizations. For example, at Block 692 the client defines values to variables having a range of possible values, e.g., possible values within a probability distribution. One example of an inserted value range is the likelihood that, the service provider organization completes a project on time, or that the service provider organization finishes within budget. These, along with the proposal information, internal performance information (e.g., performance data collected from within the client organization) and external performance information (e.g., performance data collected through out the system 10), are input to Block 680 for running Monte Carlo simulations of the possible outcomes of the project. The Monte Carlo simulations calculate, for example, multiple scenarios of the project duration, cost and quality for each service provider organization by repeatedly sampling values from the probability distributions for the inputted variables and using those values for the calculation. The results are retrieved and reviewed by the client at Block 694.

It should be appreciated that after reviewing a proposal a client 24 may post questions to a service provider 32 that has submitted the proposal requesting, for example, clarification of terms within the proposal. For example, and as shown at 794 of FIG. 12B, a client 24 may ask a service provider 32 to provide further information regarding a proposed cost value. The service provider 32 reviews the question and may respond by adjusting its proposal and resubmitting it for evaluation.

As shown at Block 696 of FIG. 10, the client 24 accepts a service provider's proposal or continues to review and negotiate terms of proposals (e.g., no service provider is selected). FIG. 12C illustrates that a portion 796 of the Verify Proposal dialog 790 includes features for automating the acceptance. At Block 698, the decision is recorded. At Block 699 the service providers 32 who are not selected to perform the projects are notified of the client's decision. The notification includes qualitative measures (absent any rankings or comments). If no service provider is selected the project record can be archived within a data store or deleted.

Referring again to FIG. 1, once a client 24 has selected a service provider/proposal, the client 24 and service provider 32 pursue contracting at Blocks 56 and 76, respectively. The system 10 loads the proposal information into a contract record. Both parties modify the contract until it is acceptable to both and the contract is then attached to the project record 550.

FIG. 15 illustrates one embodiment of a method, shown generally at 900, for creating and negotiating contracts. As noted above, proposals include information 908 (e.g., terms) by which clients 24 request services and service providers 32 agree to provide such services. Accordingly, when a proposal is accepted, these terms 908 are fed into a contract format specified by the selected project template. In one embodiment, the terms may include terms customized to the needs of a particular client at Block 902 and/or service provider at Block 904. The customized terms may contain language that the particular party prefers to use to describe such transactions. The customized and standard contract terms are combined (at Block 906) and the terms and other proposal information is used to create a contract record at Blocks 910 and 912. Once the contract is created, both parties (e.g., the client 24 and service provider 32) may review and edit the terms (at Blocks 914 and 916, respectively) until the contract is acceptable to both parties at Blocks 918 and 920, respectively. The final contract and terms are stored as part of the project record (at Block 922) and are used as a reference throughout the project lifecycle. If a contract is not accepted by both parties and further negotiations are not successful, the client can select another service provider, archive the project record or delete it.

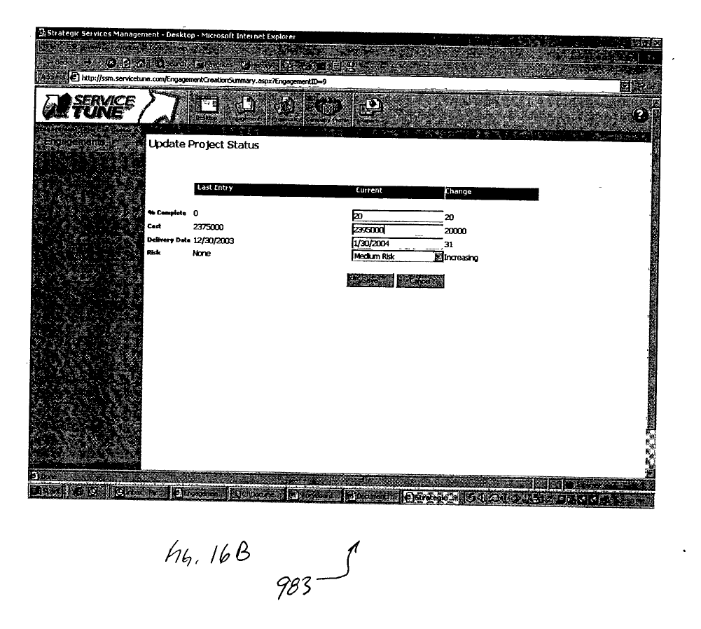

FIG. 16A illustrates a method, shown generally at 950, for managing projects in accordance with one embodiment of the present invention. When a project is created the capabilities shown generally at 952 are available. The capabilities 952 include:

an ability to review contact information of all project participants 954 such as, for example, name, phone number and email addresses;

scheduling 956 of events on a project calendar such as meetings, project participants invited to scheduled events are notified by e-mail 958 and may accept or decline to attend with a responding email;

documenting 960 tasks that need to be completed and issues that must be resolved;

posting 962 of messages to participants or the entire group, a notification is sent 964 to a participant if a message is posted for them;

viewing 966, by clients, of a list of service providers who have submitted proposals, while providers can see the status of their proposal submission at 968; and

creating 970 surveys and sending the surveys to participants whereby participants can respond through e-mail 972, however, a service provider's survey must be approved by the client at 974.

It should be appreciated that within the aforementioned capabilities 952 service providers cannot see any information about other service providers.

After a service provider has been selected for contract negotiation (e.g., at Block 54 of FIG. 1) capabilities shown generally at 980 become available. The capabilities 980 include:

reviewing and updating engagement status monitoring information in the project record at 982 using an Update Project Status dialog shown generally at 983 of FIG. 16B;

reviewing and updating contract terms (e.g., creating a Change Order) with regards to time, cost, duration, personnel, or other terms that are specified in the contract and/or project record at 984;

submitting billing information, by the service provider at 986; and

reviewing and updating billing information by the client, approval of bills for payment by the client, and forwarding of bills to payment systems and personnel at 988.

It should be appreciated that the events and information described above are recorded in the project record at 990.

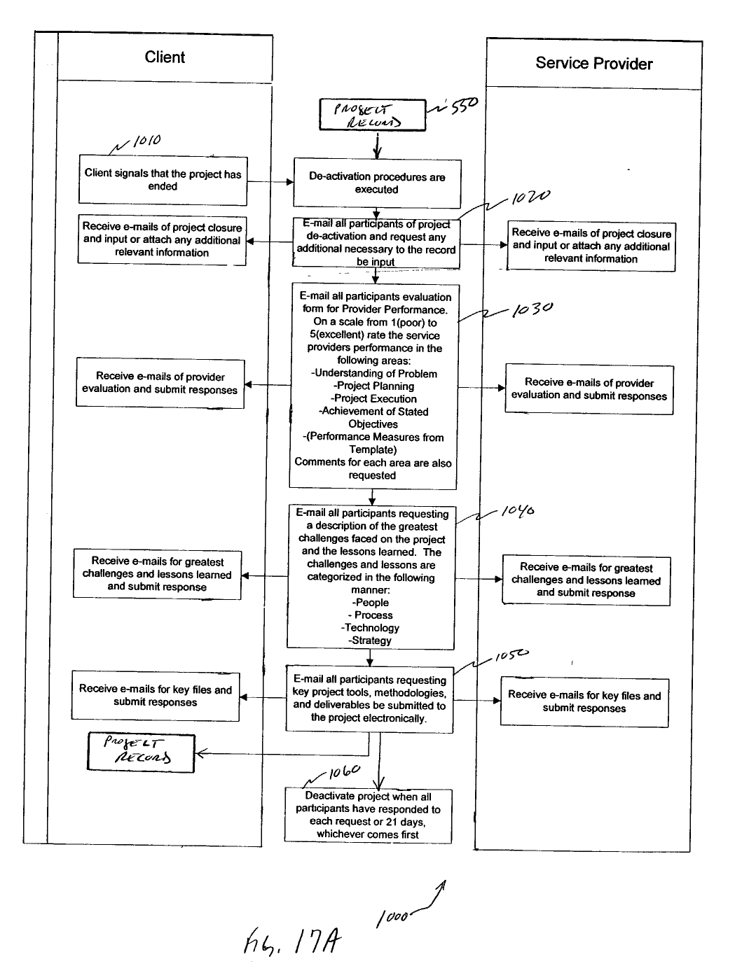

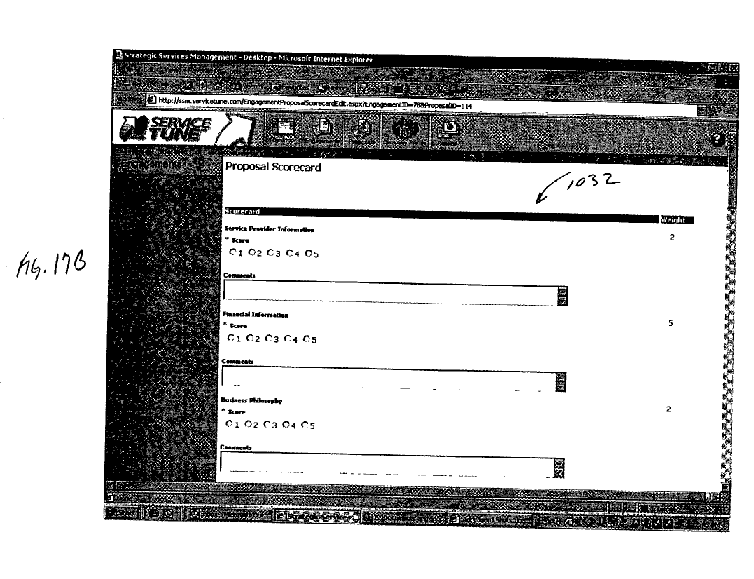

FIG. 17A illustrates a method, shown generally at 1000, for measuring performance in accordance with one embodiment of the present invention. As shown in FIG. 17A, both clients 24 and service providers 32 participate in the process of measuring performance 1000 at the conclusion of a project. At Block 1010 the client 24 records the completion of the project. Participants are notified to submit any additional information necessary for thorough documentation of the project at Block 1020.

Quantitative measures such as, for example, on-time and on-budget delivery are determined and stored automatically by the system 10. For example, for an on-time delivery calculation the system 10 compares the starting and ending dates or elapsed days as defined in the contract versus the actual start and end dates or elapsed days. For an on-budget delivery calculation, the system 10 compares the contracted cost to all the bills submitted and a corresponding over/under amount is determined. Additional quantitative measures are calculated in a similar fashion by comparing the contract terms to the actual data.

At Block 1030, the system 10 transmits (e.g., via email or other delivery mechanism) surveys to all project participants to measure qualitative criteria. The surveys use the qualitative criteria contained in the template used to define the project as well as customized criteria specified at the time the project was defined. In one embodiment, a service provider's performance is measured on the survey using a one (1) (representing “poor” performance) to five (5) (representing “excellent” performance) scale for each criteria and any comments. For example, FIG. 17 illustrates a Proposal Scorecard dialog generally at 1032 presented to participants for measuring the project and components thereof.

At Block 1040, project participants may also document any lessons learned or challenges faced on the project, which is stored as a part of the project record 550. Key project tools, methodologies and deliverables are attached to the project record 550 as computer files so that they can be used in the future on similar projects at Block 1050.

At Block 1060 the project is deactivated after all participants have submitted performance measures or within a predetermined maximum time period (e.g., about 21 days), whichever comes first. All measures are added to the project record. The recorded performance on all projects creates the foundation for performance measurement and analysis.

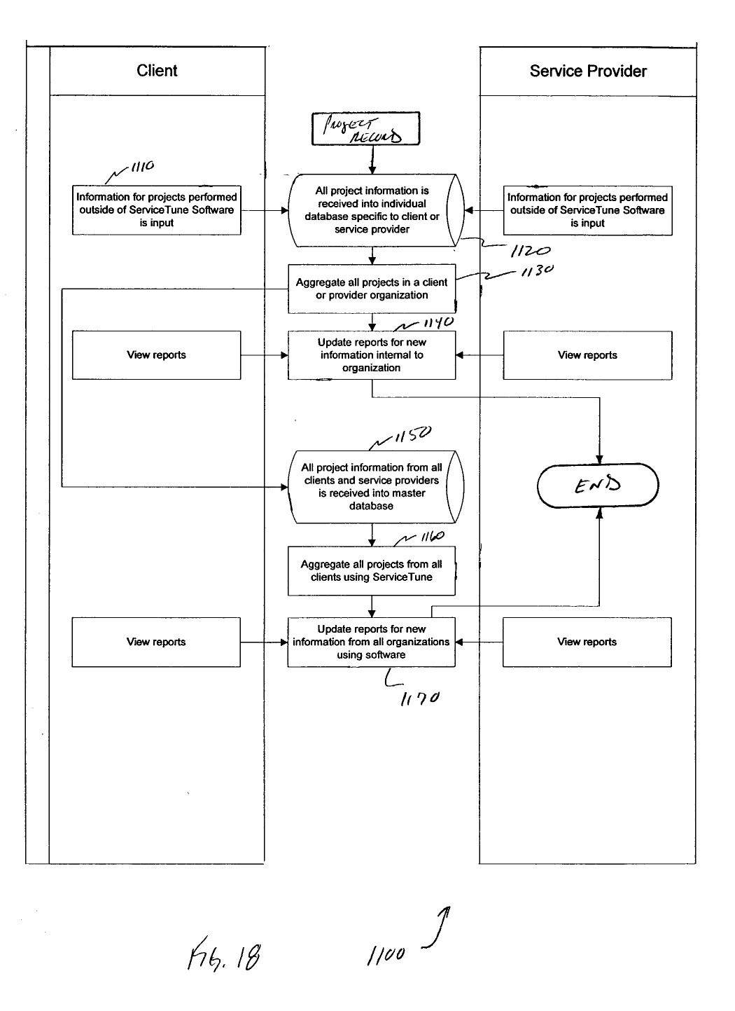

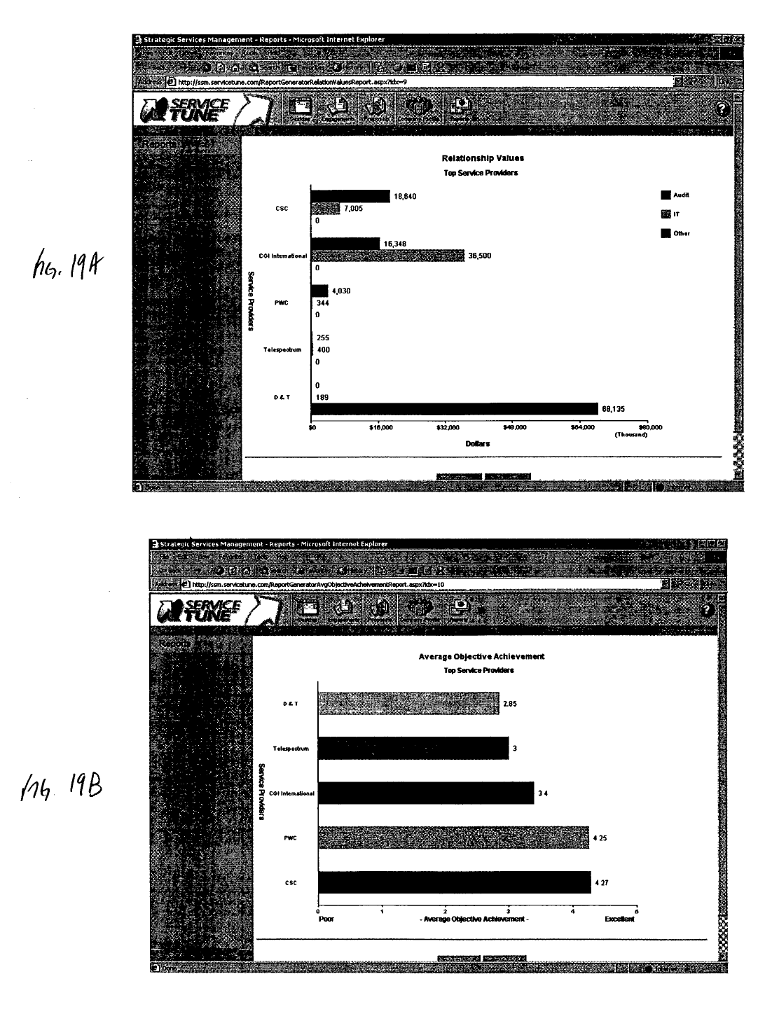

FIG. 18 illustrates a method, shown generally at 1100, for developing information for analyzing project performance information, in accordance with one embodiment of the present invention. As shown in FIG. 18, throughout a project's lifecycle, information associated with the project is captured in the project record. At Block 1110, information from projects performed outside of the system 10 is input. At Block 1120, all project information is initially stored in individual storage areas specific to a client 24 and a service provider 32. The project information is also aggregated by the system 10 and stored at Block 1130 within areas associated with the client organization 20 and service provider organization 30. At Block 1140 the system 10 retrieves the stored project information and provides reports for use in analyzing the relationships between client and service providers (depicted in FIGS. 14A and 14B for project level reporting and FIGS. 19A and 19B for enterprise level reporting (e.g., throughout the system 10)). For example, cost information is aggregated across client and service provider organizations so that the value of relationships can be measured and analyzed based on the amount of dollars and type of service as shown in FIG. 14B.

Information from all organizations is collected at Block 1150 by the system 10 and aggregated at Block 1160. This aggregated organizational information is used at Block 1170 for analysis of the knowledge services market and its participants in general. Examples of these measures include, for example:

the average dollar rate per hour charged;

the frequency service providers delivered projects late;

the frequency service providers exceeded the agreed upon price for a project;

the average amount types of projects exceeded their original budgeted price;

the average cost for a particular type of project;

the average cost for service providers in a particular region; and

the quality of services delivered by service providers as measured by their ability to achieve the project objectives created in each project and shown in FIG. 19B.

These measures are delivered to users making selection decisions (e.g., Block 54 of FIG. 1) as is information derived from aggregated data from the specific client organization. This provides a strategic context to the decisions about relationships between clients and providers of knowledge services.

Exemplary Implementation Strategies

The templates, activities, and processes described herein are embodied within the system 10, which itself is deployed on a computer processing system (e.g., one or more servers) operatively coupled to a communications network such as, for example, the Internet. Users of the system 10 (e.g., clients and service providers) access the communication network with an Internet browser or similar network interface.

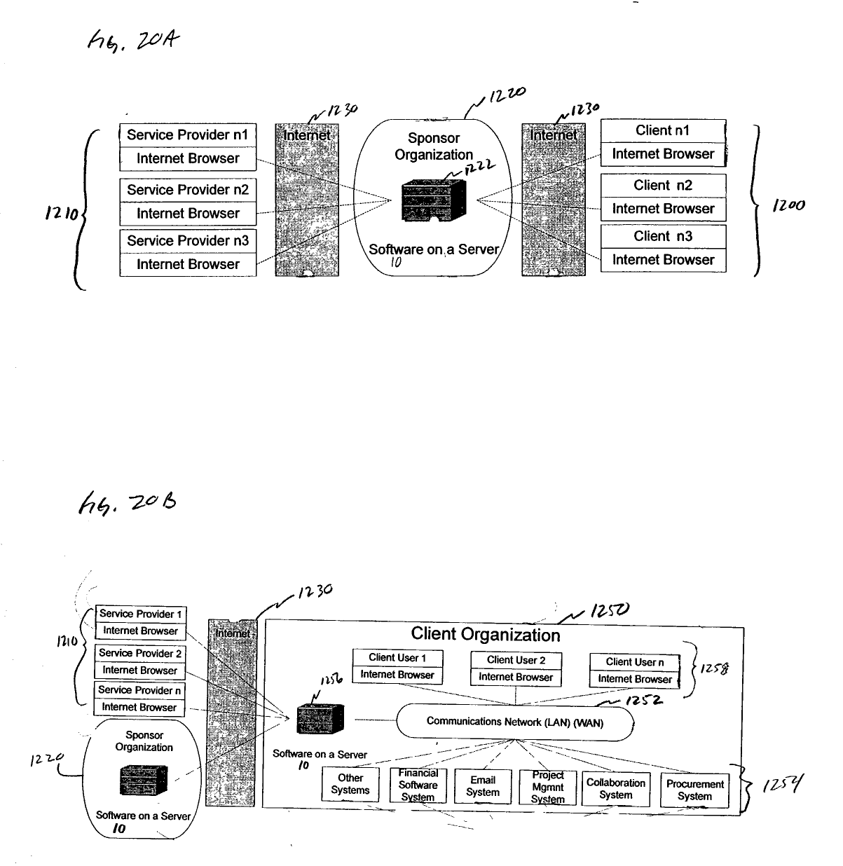

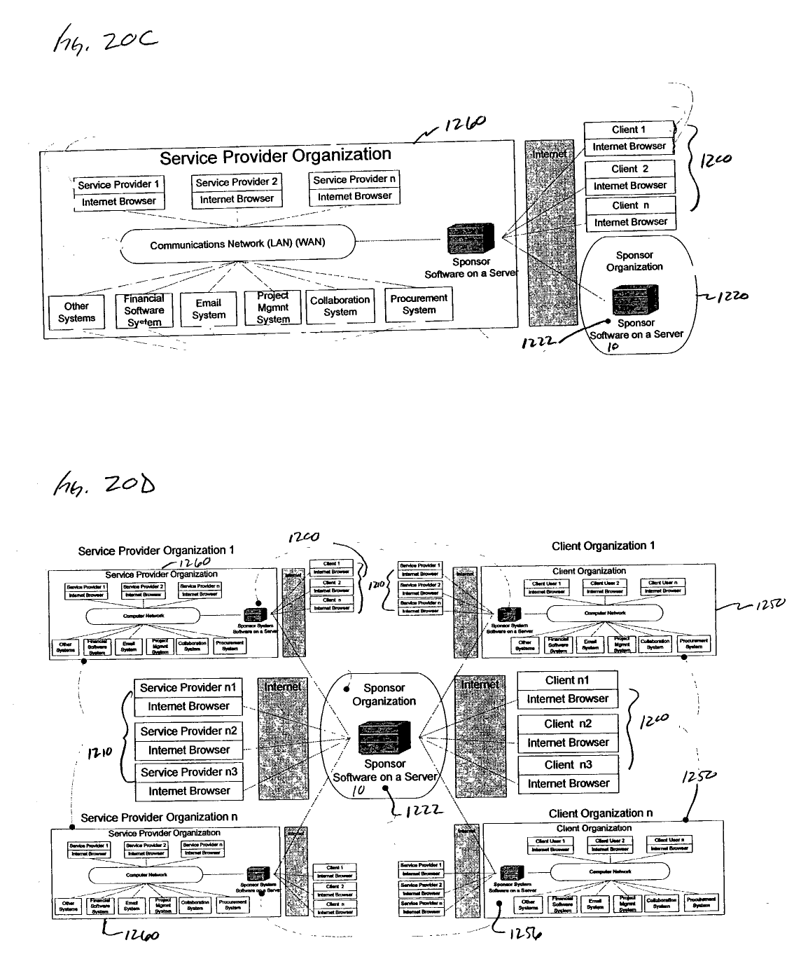

FIGS. 20A-20D depict exemplary implementation strategies, e.g., where the system 10 is implemented by individual clients, service providers and client/service provider organizations. FIG. 20A shows an implementation of individual clients, shown generally at 1200, and service providers, shown generally at 1210, who are not part of an organization that has the system 10 executing on a server in their organizations. As such, the clients 1200 and service providers 1210 connect to the system 10 running on a server 1222 located at a hosting organization 1220, referred to as a sponsor organization. Preferably, the connection to the system 10 is via an Internet connection (shown at 1230). Internet browsers 1202 and 1212 couple and permit interaction between the clients 1200, service providers 1210 and the system 10 executing on the server 1222. In this configuration client and service provider inputs and instructions are captured through the Internet browsers 1202 and 1212, respectively. Those inputs and instructions are communicated via the Internet 1230 to the server at the hosting organization 1220 where the data is processed according to the instructions provided by the system 10. Any outputs from this processing from the system 10 to the clients 1200 and/or service providers 1210 are communicated via the Internet 1230 from the server 1222 at the hosting organization 1220.

FIG. 20B shows an implementation of the system 10 at a client organization 1250. The client organization 1250 has a private communications network 1252 such as a local area network (LAN) or wide area network (WAN). This private communications network 1252 is connected to the Internet 1230. Connected to the communications network 1252 are software systems (shown generally at 1254) owned by the client organization 1250 such as financial systems, e-mail systems, project management systems, collaboration systems, and procurement systems. A server 1256 running the system 10 is operatively coupled to the communications network 1252.

Individual clients, shown generally at 1258, that are a part of the client organization 1250 connect to the communications network 1252 using an Internet browser. The clients 1258 use the Internet browser to interact with the server 1256 running the system 10 at the client organization 1250.

Service providers 1210 who are directly engaged in relationships with the client organization 1250 or individual clients 1258 within the client organization 1250 connect to the system 10 running on a server 1256 via the Internet 1230 and the private communications network 1252. They use Internet browsers 1212 to interact with the server 1256. In this configuration client and service provider inputs and instructions are captured through the Internet browser. Those inputs and instructions are communicated by the means discussed for a client or service provider to the server 1256 running the system 10 at the Client Organization 1250 where the data is processed according to the directions given by the system 10. Any outputs from this processing that the system 10 at the client organization 1250 directs to the service providers are communicated via the private communications network 1252 and the Internet 1230 and received through their Internet browser. Client outputs are communicated via the private communications network 1252. All outputs are received through the Internet browser.

FIG. 20C shows an implementation of the system 10 at a provider organization 1260. This implementation is substantially similar to the implementation of the system 10 at the client organization 1250 (FIG. 20B) except that the client and service provider's roles are reversed.

A connection to system 10 on a server 1222 at the sponsor organization 1220 is common to all implementation methods. FIG. 20D illustrates various connections to the system 10 executing on a server 1222 at the sponsor organization 1220. The system 10 running on a server 1256 at client organizations 1250 and on a server 1262 at service provider organizations 1260 sends transaction data to the system 10 on a server 1222 at the sponsor organization 1220. This transaction data is aggregated and processed by the system 10 on a server 1222 at the sponsor organization 1220.

This processing creates measures that characterize the total body of transaction data contained by the system 10 on a server 1222 at the sponsor organization 1220.

In addition to aggregating and processing information, the system 10 on a server 1222 at the sponsor organization 1220 acts as repository for the contact and profile information of service providers.

While the inventive system for managing service transactions 10 has been described and illustrated in connection with preferred embodiments, many variations and modifications, as will be evident to those skilled in this art, may be made without departing from the spirit and scope of the invention. As such, the invention is not to be limited to the precise details of methodology or construction set forth above as such variations and modification are intended to be included within the scope of the invention.

What is claimed is:

1. In a computer processing system, a method for managing service transactions, comprising:
defining a project including a plurality of activities and qualifications for performers of the plurality of activities;
preparing a Request for Proposal (RFP) from the project definition;
notifying a plurality of service providers of the RFP;
receiving proposals of prospective ones of the plurality of service providers;
ranking the received proposals based on information including evaluations of past performance of the prospective service providers;
selecting at least one of the prospective service providers to perform the project;
negotiating terms of performance with the at least one of the prospective service providers;
monitoring performance of the project;
upon completion of the project, requesting evaluations of the performance; and
storing the performance evaluations.

2. The method of claim 1 wherein the step of defining the project comprises:
reviewing a library of templates includes a plurality of predefined project definitions;
selecting a template from the template library that corresponds to the project; and
as required, modifying the predefined project definition to represent the project.

3. The method of claim 2 wherein the predefined project definitions describe at least one of service activities, evaluation criteria including quantitative and qualitative criteria, standard contract terms and conditions, status reporting and performance measurements.

4. The method of claim 1 wherein the step of preparing the RFP comprises designating project participants for approving the project and RFP.

5. The method of claim 1 wherein the step of notifying the plurality of service providers of the RFP comprises at least one of:
selecting by name a subset of the plurality of service providers to receive the notification; and
allowing unnamed ones of the plurality of service providers to receive the notification.

6. The method of claim 1 wherein the step of ranking the received proposals comprises:
evaluating past performance of the prospective service providers in terms of historical internal performance; and
evaluating past performance of the prospective service providers in terms of historical external performance.

7. The method of claim 6 wherein the evaluation of past performance includes at least one of proposal cost, average hourly rate charged per full time equivalent, completion date, regulatory/conflict of interest, service quality, value, cost overruns, and on-time delivery.

8. The method of claim 7 wherein the past performance measures are assigned a weight corresponding to a relative importance to the project, and wherein the weight is a percentage value.

9. The method of claim 1 wherein the step of selecting the at least one prospective service providers comprises:
inputting values within a range of values for performance evaluation variables; and
performing Monte Carlo analysis for estimating performance of one or more of the prospective service providers.

10. The method of claim 1 wherein the step of requesting evaluations comprises automatically generating electronic mail messages to participants of the project:
requesting relevant project information for storage with the completed project record;
requesting evaluations of service provider performance;
requesting information regarding challenges faced and lessons learned; and
requesting key project tools, methodologies and deliverables.

11. The method of claim 10 wherein the evaluations of service provider performance includes a rating in terms of the service provider's understanding of the problem, project planning, project execution, achievement of stated objectives, and comments relating to any of the foregoing.

12. A method for managing service transactions, comprising:
preparing a Request for Proposal (RFP) from a project definition;
receiving proposals of prospective ones of a plurality of service providers to complete the RFP;
ranking the received proposals based on evaluations of past performance of the prospective service providers, the past performance evaluations included weighted categories of activities and qualifications of the service providers and wherein the weight is a percentage value corresponding to a relative importance of the activities and qualification to the project;
selecting at least one of the prospective service providers to perform the project; and
upon completion of the project, requesting evaluations of the performance.
